(19) United States
(12) Patent Application Publication
(10) Pub. No.: US 2018/0291681 A1
(43) Pub. Date: Oct. 11, 2018

(54) DAYLIGHTING MEMBER, METHOD FOR MANUFACTURING DAYLIGHTING MEMBER, AND DAYLIGHTING APPARATUS

(71) Applicant: SHARP KABUSHIKI KAISHA, Sakai City, Osaka (JP)

(72) Inventors: TORU KANNO, Sakai City (JP); SHUMPEI NISHINAKA, Sakai City (JP); DAISUKE SHINOZAKI, Sakai City (JP); SHUN UEKI, Sakai City (JP); TSUYOSHI KAMADA, Sakai City (JP)

(21) Appl. No.: 15/765,817

(22) PCT Filed: Oct. 6, 2016
(86) PCT No.: PCT/JP2016/079814

§ 371 Date: Apr. 4, 2018

(30) Foreign Application Priority Data
Oct. 9, 2015 (JP) 2015-201210

(51) Int. Cl. E06B 9/386; F21S 11/00; F21V 7/00; E06B 9/42

(52) U.S. Cl. CPC E06B 9/386; E06B 9/42; F21V 7/0091; F21S 11/007

(57) ABSTRACT

A daylighting member according to an aspect of the present invention includes a plurality of substrates having a light transmitting property; a plurality of daylighting portions having a light transmitting property, the plurality of daylighting portions extending linearly on a first surface of each of the substrates and extending in different directions on different substrates; and a gap portion provided between the plurality of daylighting portions. The plurality of substrates include at least a first substrate or a second substrate, the first substrate having a first daylighting portion inclined at an angle θ1 relative to an edge side of the substrate, the second substrate having a second daylighting portion inclined at an angle θ2 relative to the edge side.

### TECHNICAL FIELD

Some aspects of the present invention relate to a daylighting member, a method for manufacturing a daylighting member, and a daylighting apparatus.

The present application claims priority to Japanese Patent Application No. 2015-201210, filed on Oct. 9, 2015, the content of which is incorporated herein.

### BACKGROUND ART

As a technique for guiding light incident on a window pane into an interior of a building, for example, known is a daylighting apparatus that, with the use of a daylighting sheet in which a daylighting portion or the like constituted by a plurality of prism bodies is formed on one surface of a substrate, can direct light incident on a window pane toward a ceiling, a side wall, a floor, or the like in a building while changing the traveling direction of the light with the prism bodies (PTL 1).

### CITATION LIST

### Patent Literature

PTL 1: Japanese Unexamined Patent Application Publication No. 2013-156554

### SUMMARY OF INVENTION

### Technical Problem

However, in the conventional daylighting apparatus, grooves in the prisms in the daylighting portion have microstructure shapes that are arranged in one direction so as to be parallel to a floor surface, and the emission in a direction perpendicular to the grooves in the prism is intense. Thus, depending on the latitude or a difference in the orientation of a window or depending on the altitude of the sun, the daylighting property toward the ceiling may decrease, or the light may be distributed into the line of sights of a person inside the room, causing the person to experience unpleasant glare.

An aspect of the present invention has been made in view of the problem with the conventional technique described above and is directed to provide a daylighting member, a method for manufacturing a daylighting member, and a daylighting apparatus that can suppress intense glare light emerging in a specific direction.

### Solution to Problem

A daylighting member according to an aspect of the present invention includes a plurality of substrates having a light transmitting property; a plurality of daylighting portions having a light transmitting property, the plurality of daylighting portions extending linearly on a first surface of each of the substrates and extending in different directions on different substrates; and a gap portion provided between the plurality of daylighting portions. The plurality of substrates include at least a first substrate or a second substrate, the first substrate having a first daylighting portion inclined at a first angle θ1 relative to an edge side of the substrate, the second substrate having a second daylighting portion inclined at a second angle θ2 relative to the edge side.

In the daylighting member according to an aspect of the present invention, a configuration may be such that the first substrate is provided in a plurality and the respective first daylighting portions of the plurality of first substrates are inclined at mutually different first angles θ1.

In the daylighting member according to an aspect of the present invention, a configuration may be such that the second substrate is provided in a plurality and the respective second daylighting portions of the plurality of second substrates are inclined at mutually different second angles θ2.

In the daylighting member according to an aspect of the present invention, a configuration may be such that the first substrate, the first substrate, and the second substrate are arrayed in a direction intersecting the edge side.

In the daylighting member according to an aspect of the present invention, a configuration may be such that the first substrate, the first substrate, and the second substrate are arrayed in a direction parallel to the edge side.

In the daylighting member according to an aspect of the present invention, a configuration may be such that a first substrate having a third daylighting portion that is parallel to an edge side of the substrate is further provided.

A daylighting member according to an aspect of the present invention includes a substrate having a light transmitting property; a plurality of daylighting portions having a light transmitting property, the plurality of daylighting portions extending linearly on a first surface of the substrate; and a gap portion provided between the plurality of daylighting portions. The first surface includes at least a first region or a second region, the first region having a first daylighting portion inclined at a first angle θ1 relative to an edge side of the substrate, the second region having a second daylighting portion inclined at a second angle θ2 relative to the edge side.

In the daylighting member according to an aspect of the present invention, a configuration may be such that the first region is provided in a plurality and the respective first daylighting portions of the plurality of first regions are inclined at mutually different first angles θ1.

In the daylighting member according to an aspect of the present invention, a configuration may be such that the second region is provided in a plurality and the respective second daylighting portions of the plurality of second regions are inclined at mutually different second angles θ2.

In the daylighting member according to an aspect of the present invention, a configuration may be such that the first region and the second region are arrayed in a direction intersecting the edge side.

In the daylighting member according to an aspect of the present invention, a configuration may be such that the first region and the second region are arrayed in a direction parallel to the edge side.

A daylighting member according to an aspect of the present invention includes a substrate having a light transmitting property; a plurality of daylighting portions having a light transmitting property, the plurality of daylighting portions extending linearly on a first surface of the substrate; and a gap portion provided between the plurality of daylighting portions. The first surface includes a plurality of first regions or a plurality of second regions, the plurality of first regions having a first daylighting portion inclined at a first angle θ1 relative to an edge side of the substrate, the plurality of second regions having a second daylighting portion inclined at a second angle θ2 relative to the edge side, the first regions or the second regions being present in a plurality in one direction.

In the daylighting member according to an aspect of the present invention, the second regions and the third regions are present alternatingly in a repeated manner in one direction.

In the daylighting member according to an aspect of the present invention, a configuration may be such that a plurality of third regions having a first daylighting portion that is parallel to an edge side of the substrate are further provided.

In the daylighting member according to an aspect of the present invention, a configuration may be such that the first angle θ1 is within a range of 0°≤θ1≤30° and the second angle θ2 is within a range of −30°≤θ2<0°.

In the daylighting member according to an aspect of the present invention, a configuration may be such that the first daylighting portion and the second daylighting portion are inclined symmetrically with respect to a direction intersecting a direction in which the first daylighting portion and the second daylighting portion are arranged.

In the daylighting member according to an aspect of the present invention, a configuration may be such that the edge side is a side extending along a lengthwise direction of the substrate.

A method for manufacturing a daylighting member according to an aspect of the present invention includes cutting out, from a whole cloth roll manufactured with the use of a roll-to-roll technique, a plurality of the first daylighting portions and a plurality of the second daylighting portions.

A method for manufacturing a daylighting member according to an aspect of the present invention includes cutting out, from a whole cloth roll manufactured with the use of a roll-to-roll technique, a plurality of the first daylighting portions and a plurality of the second daylighting portions, thereby obtaining the first substrate, the first substrate, and the second substrate.

A daylighting apparatus according to an aspect of the present invention includes a plurality of slats and a support mechanism that couples the plurality of slats with a lengthwise direction of the slats extending in a horizontal direction and supports the plurality of slats in a state of being suspended in a vertical direction. The plurality of slats include the daylighting member described above.

A daylighting apparatus according to an aspect of the present invention includes a daylighting screen and a take-up mechanism that allows the daylighting screen to be taken up freely. The daylighting screen includes the daylighting member described above.

A daylighting apparatus according to an aspect of the present invention includes a substrate and a frame that supports the substrate at a periphery. The daylighting member described above is provided on one surface of the substrate.

### Advantageous Effects of Invention

According to some of the aspects of the present invention, a daylighting member, a method for manufacturing a daylighting member, and a daylighting apparatus that can suppress intense glare light emerging in a specific direction can be provided.

### BRIEF DESCRIPTION OF DRAWINGS

FIG. 1 is a perspective view illustrating an appearance of a blind according to a first embodiment.

FIG. 2 illustrates the blind according to the first embodiment, as viewed from the side.

FIG. 3A is a front view illustrating a schematic configuration of a daylighting slat constituting a daylighting region.

FIG. 3B illustrates a schematic configuration of a daylighting slat constituting a daylighting region and is a sectional view taken along the A-A′ line indicated in FIG. 3A.

FIG. 4A is a perspective view of a daylighting sheet.

FIG. 4B is a sectional view of a daylighting portion in a daylighting sheet.

FIG. 5 illustrates angles of inclination of daylighting portions in each daylighting slat.

FIG. 6A is a perspective view in which a primary portion of a blind is enlarged and illustrates an open state.

FIG. 6B is a perspective view in which a primary portion of a blind is enlarged and illustrates a closed state.

FIG. 7 is a schematic diagram illustrating an example of a room model in which a blind is installed.

FIG. 8 is a perspective view for describing functions of a daylighting region and a shading region of a blind.

FIG. 9 is an illustration for describing a daylighting function served by a daylighting slat.

FIG. 10 illustrates a daylighting state into a room by a conventional daylighting sheet that is affixed to a window pane, as viewed from a ceiling.

FIG. 11A illustrates a diffusion state (an occurrence state of glare light) of light that exits from a conventional daylighting sheet, as viewed from the interior of a room.

FIG. 11B is a sectional view taken along the B-B′ line indicated in FIG. 11A.

FIG. 12 illustrates a daylighting state into a room in which a blind according to an aspect of the present invention is installed, as viewed from a ceiling.

FIG. 13 illustrates a diffusion state (an occurrence state of glare light) of light that exits from a blind according to an aspect of the present invention, as viewed from the interior of a room.

FIG. 14A is a first diagram illustrating a modification of a daylighting slat.

FIG. 14B is a second diagram illustrating a modification of a daylighting slat.

FIG. 14C is a third diagram illustrating a modification of a daylighting slat.

FIG. 14D is a fourth diagram illustrating a modification of a daylighting slat.

FIG. 15A is a sectional view illustrating another modification of a daylighting slat and is a first diagram illustrating a structure of the daylighting slat to which a light diffusing function has been added.

FIG. 15B is a sectional view illustrating another modification of a daylighting slat and is a second diagram illustrating a structure of the daylighting slat to which a light diffusing function has been added.

FIG. 16 is a perspective view illustrating an overall configuration of a roll screen (a daylighting apparatus) according to a second embodiment.

FIG. 17 is a side view illustrating an overall configuration of the roll screen according to the second embodiment.

FIG. 18A is a first diagram illustrating a configuration of a daylighting slat according to the second embodiment.

FIG. 18B is a second diagram illustrating a configuration of the daylighting slat according to the second embodiment.

FIG. 19 is a perspective view illustrating an overall configuration of a roll screen (a daylighting apparatus) according to a third embodiment.

FIG. 20A is a side view illustrating an overall configuration of the roll screen according to the third embodiment.

FIG. 20B is an enlarged sectional view of a portion enclosed by a dashed-dotted circle indicated in FIG. 20A.

FIG. 21 is a perspective view illustrating an overall configuration of a daylighting panel (a daylighting apparatus) according to a fourth embodiment.

FIG. 22A is a front view illustrating a schematic configuration of a daylighting panel main body according to the fourth embodiment.

FIG. 22B is a sectional view taken along the C-C′ line indicated in FIG. 22A.

FIG. 23A is a plan view illustrating a schematic configuration of a daylighting slat according to a modification.

FIG. 23B is a sectional view taken along the D-D′ line indicated in FIG. 23A.

FIG. 24A is a plan view illustrating a schematic configuration of a daylighting panel according to a modification.

FIG. 24B is a sectional view taken along the E-E′ line indicated in FIG. 24A.

FIG. 25 is a plan view in which a plurality of daylighting members with their lengthwise direction extending in an up-down direction are tiled according to a comparative example.

FIG. 26A is a front view illustrating a schematic configuration of a daylighting apparatus according to a fifth embodiment.

FIG. 26B is a daylighting image diagram obtained when the daylighting apparatus according to the fifth embodiment is installed at a window in a room.

FIG. 27 illustrates a modification of the daylighting apparatus according to the fifth embodiment.

FIG. 28A is a front view illustrating a configuration of a conventional daylighting apparatus.

FIG. 28B is a daylighting image diagram obtained when the conventional daylighting apparatus is installed at a window in a room.

FIG. 29A illustrates a modification of the fifth embodiment.

FIG. 29B is a daylighting image diagram obtained when a daylighting apparatus according to a modification is installed at a window facing east.

FIG. 30A is a first diagram for describing a method for manufacturing a daylighting sheet 10A.

FIG. 30B is a second diagram for describing a method for manufacturing the daylighting sheet 10A.

FIG. 30C is a third diagram for describing a method for manufacturing the daylighting sheet 10A.

FIG. 31A is a diagram for obtaining a daylighting sheet 10B.

FIG. 31B is a diagram for obtaining a daylighting sheet 10C.

FIG. 31C illustrates the obtained daylighting sheets 10B and 10C.

FIG. 32 is a graph illustrating a relationship between an inclination(°) of a daylighting shape in the daylighting sheet 10B and a length (mm) in a lengthwise direction.

FIG. 33 illustrates a room model provided with a daylighting apparatus and an illumination control system and is a sectional view taken along the J-J′ line indicated in FIG. 34.

FIG. 34 is a side view illustrating a ceiling of the room model.

### DESCRIPTION OF EMBODIMENTS

Hereinafter, embodiments of the present invention will be described with reference to the drawings.

In the drawings referred to in the following descriptions, the scales of the members are modified as appropriate in order to depict each member in a recognizable size.

In addition, in the following descriptions, the positional relationship (up-down, right-left, and front-back) in a daylighting apparatus is based on the positional relationship (up-down, right-left, and front-back) in the daylighting apparatus while being used. Unless otherwise specified in particular, the positional relationship in daylighting apparatuses in the drawings coincides with the positional relationship with respect to the paper planes.

### First Embodiment

Hereinafter, a configuration of a blind serving as a first embodiment of the present invention will be described.

In the following drawings, the dimensions may be indicated in different scales for different constituent elements in order to show each constituent element more clearly.

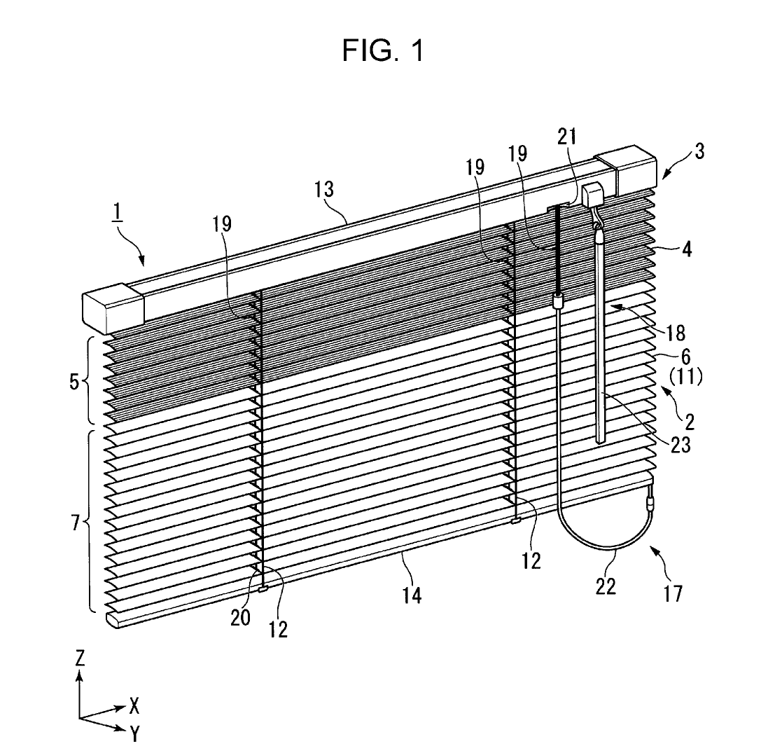

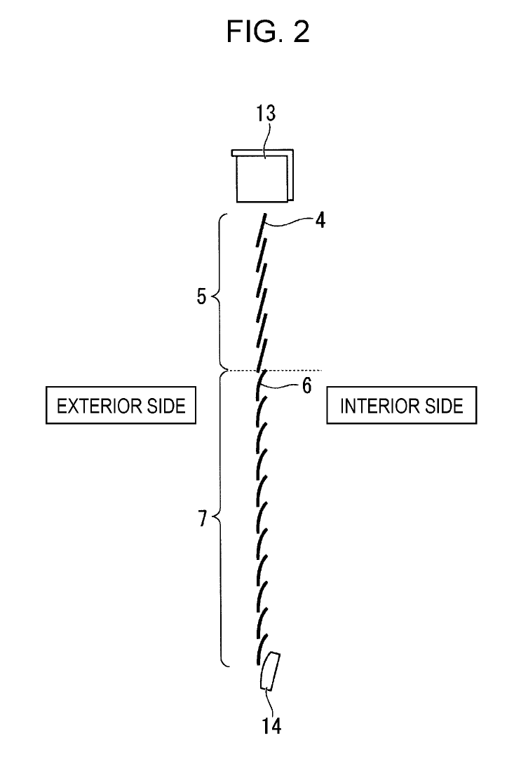

FIG. 1 is a perspective view illustrating an appearance of a blind according to the first embodiment. The up-down direction, the right-left direction, and the front-back direction of the blind illustrated in FIG. 1 are regraded as the Z-direction, the X-direction, and the Y-direction, respectively. FIG. 2 illustrates the blind according to the first embodiment as viewed from the side.

As illustrated in FIG. 1, a blind (a daylighting apparatus) 1 according to the present embodiment is primarily constituted by a plurality of slats 2 that are arranged so as to be parallel to a horizontal direction (the X-direction) with a gap provided therebetween and a support mechanism 3 that supports the plurality of slats 2 so as to freely suspend the plurality of slats 2 in a vertical direction (the Z-direction). In the blind 1, the plurality of slats 2 are supported so that the plurality of slats 2 can be raised or lowered freely and can be tilted freely.

As illustrated in FIG. 1 and FIG. 2, the plurality of slats 2 include a daylighting region 5 constituted by a plurality of daylighting slats 4 having a daylighting property and a shading region 7 located underneath the daylighting region 5 and constituted by a plurality of shading slats 6 having a shading property. In the following descriptions, when the daylighting slats 4 and the shading slats 6 are not distinguished therebetween in particular, they are collectively referred to as the slats 2.

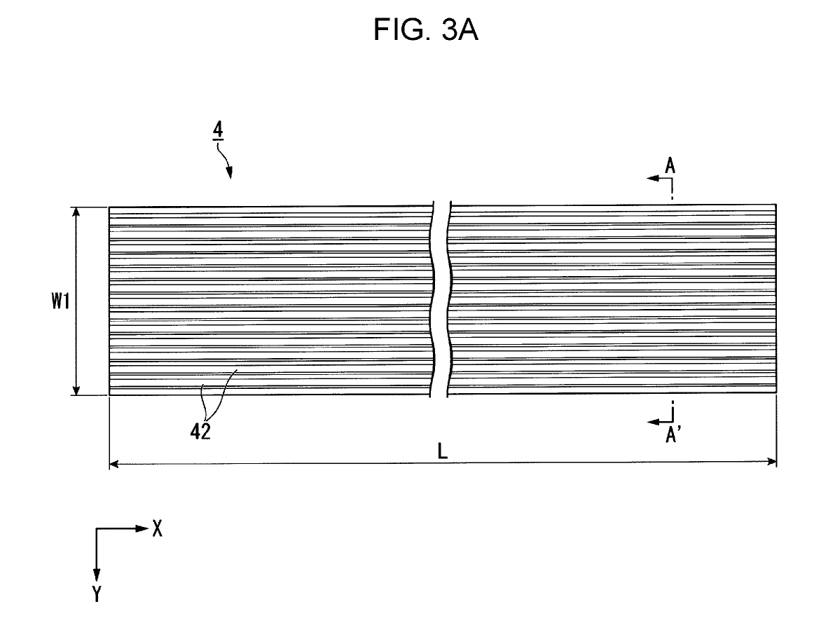

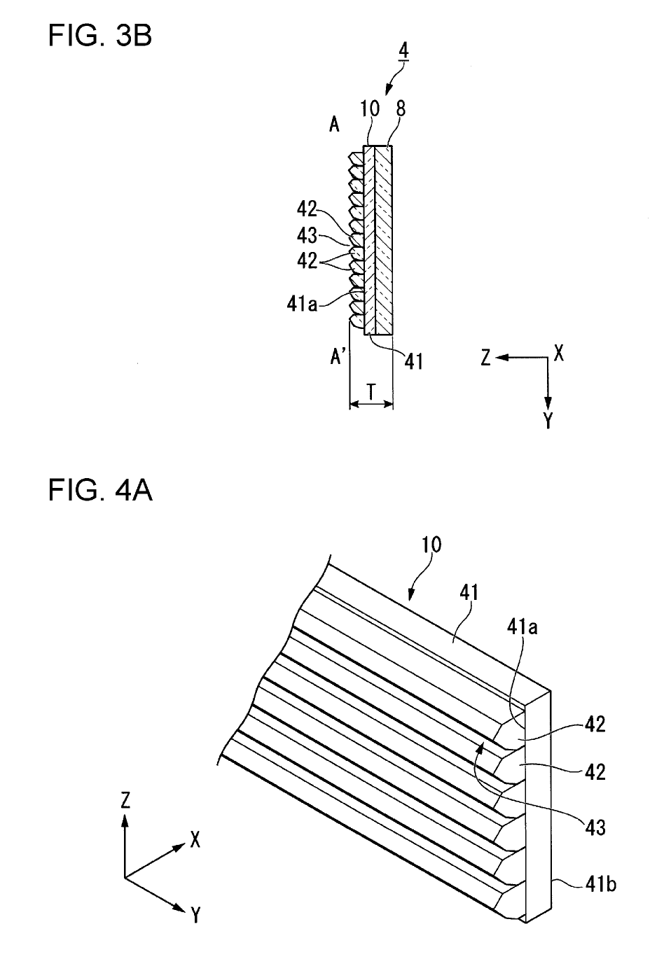

FIG. 3A and FIG. 3B illustrate a schematic configuration of a daylighting slat constituting the daylighting region, in which FIG. 3A is a front view and FIG. 3B is a sectional view taken along the A-A′ line indicated in FIG. 3A.

As illustrated in FIG. 3A and FIG. 3B, the daylighting slats 4 constituting the daylighting region 5 each include a slat main body 8 that extends in one direction and a daylighting sheet (a daylighting member) 10 provided on one surface of the slat main body 8. The daylighting slat 4 has a dimension L in the lengthwise direction of approximately 1000 mm, a dimension (a slat width) W1 in the widthwise direction of approximately 25 mm, and a thickness T of 1 mm.

The slat main body 8 is constituted by an elongated plate-like transparent substrate having a light transmitting property.

As illustrated in FIG. 3A, the daylighting sheet 10 includes a substrate 41 having a rectangular shape along a section (A-A′) perpendicular to the lengthwise direction (the X-direction), a plurality of daylighting portions 42 provided on a first surface 41a of the substrate 41 and having a light transmitting property, and gap portions 43 provided between the plurality of daylighting portions 42.

The substrate 41 is made of a light transmitting resin, such as a thermoplastic polymer, a thermosetting resin, or a photopolymerizing resin. In addition, as the light transmitting resin, one made from an acryl-based polymer, an olefin-based polymer, a vinyl-based polymer, a cellulose-based polymer, an amide-based polymer, a fluorine-based polymer, a urethane-based polymer, a silicone-based polymer, an imide-based polymer, or the like can be used. Among the above, for example, a polymethyl methacrylate resin (PMMA), triacetyl cellulose (TAC), polyethylene terephthalate (PET), a cyclo olefin polymer (COP), polycarbonate (PC), polyethylene naphthalate (PEN), polyether sulphone (PES), polyimide (PI), or the like can be used favorably. It is preferable that the total light transmittance of the substrate 41 be no lower than 90% under the JIS K7361-1 standard. This makes it possible to obtain sufficient transparency.

The daylighting portions 42 are made, for example, of an organic material having a light transmitting property and a photosensitive property, such as an acrylic resin, an epoxy resin, or a silicone resin. In addition, those obtained by mixing a polymerization initiator, a coupling agent, a monomer, an organic solvent, or the like into the aforementioned organic materials can be used. Furthermore, the polymerization initiator may contain a variety of additive components, such as a stabilizer, an inhibitor, a plasticizer, a fluorescent brightener, a parting agent, a chain transfer agent, or other photopolymerizing monomers. Aside from the above, the materials described in Japanese Patent No. 4129991 can be used. It is preferable that the total light transmittance of the daylighting portions 42 be no lower than 90% under the JIS K7361-1 standard. This makes it possible to obtain sufficient transparency.

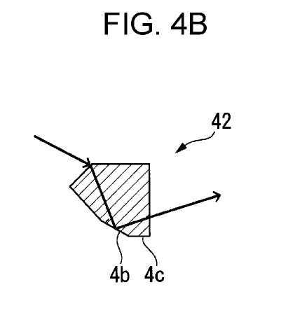

The daylighting portions 42 constituting the daylighting slat 4 extend in the lengthwise direction (the X-direction) of the substrate 41 and are arranged side by side in the widthwise direction (the Y-direction) of the substrate 41A. The daylighting portions 42 each constitute a prism body having a hexagonal section. The shape of the daylighting portion 42 is not limited to the one with a hexagonal section. The daylighting portion 42 may have a pentagonal section or a triangular section or may have a multi-tapered shape, and the shape is not particularly limited. Thus, as illustrated in FIG. 4A, when the sunlight transmitted through a window pane is incident on the daylighting portion 42, the sunlight is reflected inside the daylighting portion 42 and exits in a direction obliquely upward.

The air (the gap portion 43) is present between the plurality of daylighting portions 42, but the gap portion 43 may be charged with another material having a low refractive index. However, the difference in the refractive index at an interface between the daylighting portion 42 and the gap portion 43 is maximized when the air is present therein, as compared to cases in which any of the materials with a low refractive index is present outside the daylighting portion 42. Therefore, when the air is present, as illustrated in FIG. 4B, the critical angle of the light that undergoes total reflection at a reflection surface 4b or a reflection surface 4c, among the light incident on the daylighting portion 42, is minimized in accordance with Snell's law. Thus, the range of angles of incidence of light that undergoes total reflection at the reflection surface 4b or the reflection surface 4c is maximized, which makes it possible to guide the light incident on the daylighting portion 42 to a second surface 41b (FIG. 4A) of the substrate 41 with high efficiency. As a result, a loss of light incident on the daylighting portion 42 can be suppressed, and the luminance of the light that exits from the other surface of the substrate 41 can be increased.

It is desirable that the refractive index of the substrate 41 and the refractive index of the daylighting portion 42 be substantially the same. For example, if the refractive index of the substrate 41 and the refractive index of the daylighting portion 42 differ from each other to a great extent, when light exits from the daylighting portion 42 and is incident on the substrate 41, unwanted refraction or reflection of light may occur at an interface between the daylighting portion 42 and the substrate 41. This case may lead to disadvantages including that desired daylighting characteristics cannot be obtained and that the luminance decreases.

### Ratio of Angles of Daylighting Portions

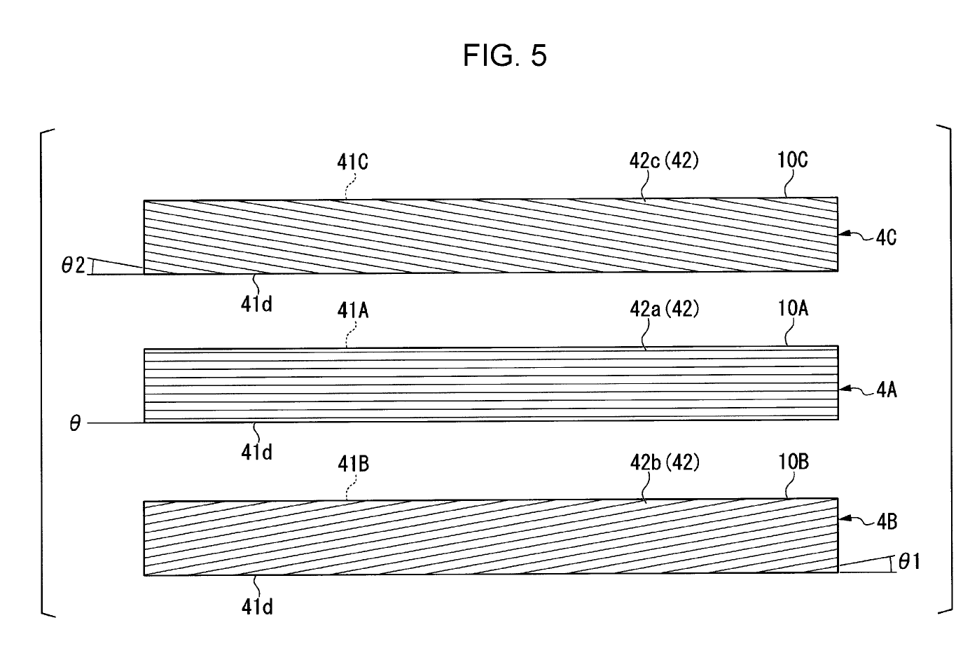

FIG. 5 illustrates angles of inclination of the daylighting portions in each daylighting slat.

As illustrated in FIG. 5, the daylighting region 5 illustrated in FIG. 1 is constituted by three types of daylighting slats 4A, 4B, and 4C that differ from one another in a daylighting direction (an exit direction), and the daylighting slats 4A, 4B, and 4C are arrayed in this order in a repeated manner in the vertical direction (the Z-direction).

The daylighting slats 4A, 4B, and 4C include daylighting sheets 10A, 10B, and 10C, respectively, that differ from one another in the direction in which the plurality of daylighting portions 42 extend.

Specifically, a plurality of daylighting portions (third daylighting portions) 42a in the daylighting sheet 10A constituting the daylighting slat 4A extend in the lengthwise direction (the X-direction) of a substrate (a first substrate) 41A so as to be parallel to an edge side 41d extending along a direction in which the substrate 41A extends and are arranged side by side in the widthwise direction (the Y-direction) of the substrate 41A. In other words, the angle of inclination of the daylighting portion 42a relative to the edge side 41d is 0°.

A plurality of daylighting portions (first daylighting portions) 42b in the daylighting sheet 10B of the daylighting slat 4B extend in one direction at a first angle θ1 relative to an edge side 41d of a substrate (a first substrate) 41B and are arranged side by side in a direction intersecting the direction in which the daylighting portions 42b extend. The first angle θ1 is set within a range of 0°≤θ1≤30°, and the first angle θ1 is 10° in the present embodiment.

A plurality of daylighting portions (second daylighting portions) 42c in the daylighting sheet 10C of the daylighting slat 4C extend in one direction at a second angle θ2 relative to an edge side 41d of a substrate (a second substrate) 41C and are arranged side by side in a direction intersecting the direction in which the daylighting portions 42c extend. The second angle θ2 is set within a range of −30°≤θ2<0°, and the second angle θ2 is −10° in the present embodiment.

In the present embodiment, the substrate 41B that includes the daylighting portions 42b having the first angle θ1 of +10° and the substrate 41C that includes the daylighting portions 42c having the second angle θ2 of −10° are provided. Alternatively, the configuration may be such that a plural sets of other substrates in which the angles (the angle θ1 and the angle θ2) of inclination of the daylighting portions differ are provided. For example, the configuration may be such that the total of five types of daylighting sheets are provided. Specifically, two types of daylighting sheets in which each of the daylighting portions 42 is inclined at an angle θ1 of +10° or +20°, a daylighting sheet in which the daylighting portions 42 are inclined at an angle of 0°, and two types of daylighting sheets in which each of the daylighting portions 42 is inclined at an angle θ2 of −10° or −20° may be provided. The type and the number of the daylighting sheets to be used are not limited to the above example, and six or more types of daylighting sheets or less than five types of daylighting sheets may be provided. A daylighting sheet in which the angle of inclination of the daylighting portions 42 further differs may be provided.

The relationship of the ratio of the angles of the daylighting portions 42a, 42b, and 42c in the respective daylighting slats 4A, 4B, and 4C is 0°:10°:−10°=1:1:1. The relationship of the ratio of the angle of the daylighting portions 42a, 42b, and 42c described above is an example and can be modified as appropriate.

In addition, in the present embodiment, the daylighting portions 42b and the daylighting portions 42c of the respective daylighting slats 4B and 4C are inclined symmetrically with respect to the direction intersecting the direction in which the daylighting portions 42b and 42c are arrayed (the Z-direction indicated in FIG. 1). Alternatively, the angles of inclination of the daylighting portions 42b and the daylighting portions 42c may be asymmetric via the daylighting portions 42a.

Referring back to FIG. 1, the shading slats 6 constituting the shading region 7 are each constituted by an elongated shading substrate 11 having a shading property. It suffices that the shading substrate 11 be one typically used as a slat for a blind, and the shading substrate 11 can be made of metal, wood, or resin, for example. In addition, the shading substrate 11 can have a coated surface.

Not all the shading slats 6 constituting the shading region 7 need to have a high shading property. For example, some of the shading slats 6 constituting the shading region 7 may be constituted by a slat having a light diffusing property or a colored slat having been colored and having a light transmitting property. In this manner, constituting all or some of the shading slats 6 by slats with a light diffusing property or colored slats makes it possible to increase the brightness inside a room as compared to the case in which slats that completely block the outside light are used.

In addition, excessive glare light does not enter into the line of sights of a person inside the room or does not hit a personal computer monitor, and thus a comfortable indoor environment can be obtained. Furthermore, there is no need to worry that the inside of the room is seen from the outside, and the privacy of a person inside the room can be protected.

The support mechanism 3 includes a plurality of ladder cords 12 arranged so as to be parallel to the vertical direction (the widthwise direction of the plurality of slats 2), an anchor box 13 that supports the plurality of ladder cords 12 at upper end portions thereof, and a raising/lowering bar 14 attached to the lower end portions of the plurality of ladder cords 12.

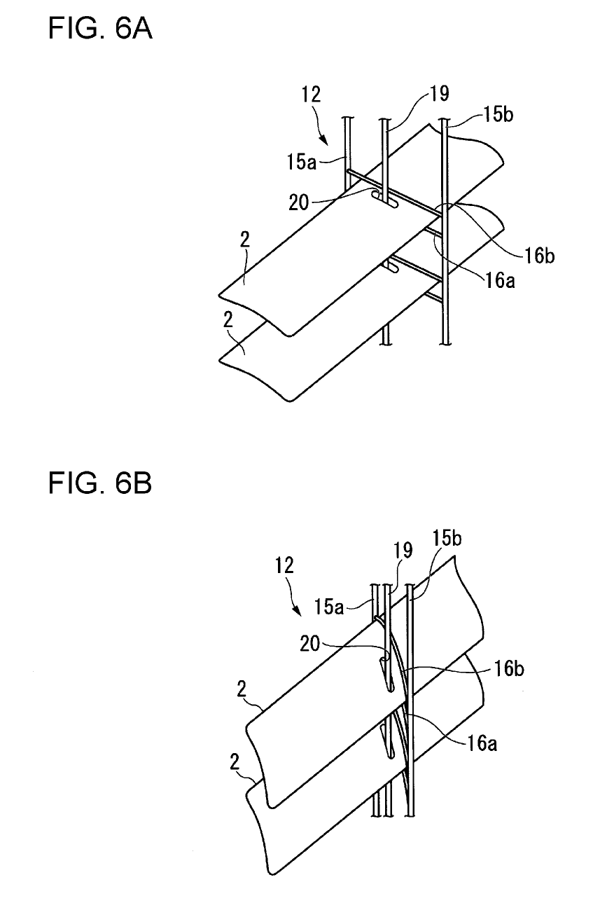

FIG. 6A and FIG. 6B are perspective views of the blind 1 in which a primary portion of the blind 1 is enlarged. FIG. 6A illustrates a state in which the space between the slats 2 is open, and FIG. 6B illustrates a state in which the space between the slats 2 is closed.

Two ladder cords 12 are disposed at the respective right and left sides across the middle portions of the plurality of slats 2. As illustrated in FIG. 6A and FIG. 6B, each of the ladder cords 12 includes a pair of front and back longitudinal cords 15a and 15b that are arranged so as to be parallel to each other and a pair of upper and lower transverse cords 16a and 16b that extend between the longitudinal cords 15a and 15b. The ladder cords 12 each have a configuration in which the transverse cords 16a and 16b are disposed side by side at an equal interval in the lengthwise direction (the vertical direction) of the longitudinal cords 15a and 15b.

Each of the slats 2 are disposed in a state of being inserted between the longitudinal cords 15a and 15b and between the transverse cords 16a and 16b.

As illustrated in FIG. 1, the anchor box 13 is located at the uppermost portion of the plurality of slats 2 arranged so as to be parallel to one another and is disposed so as to be parallel to the plurality of slats 2. Meanwhile, the raising/lowering bar 14 is located at the lowermost portion of the plurality of slats 2 arranged so as to be parallel to one another and is disposed so as to be parallel to the plurality of slats 2. The longitudinal cords 15a and 15b constituting each of the ladder cords 12 are suspended from the anchor box 13 in a state in which the longitudinal cords 15a and 15b are stretched in a vertically downward direction by the weight of the raising/lowering bar 14.

The support mechanism 3 includes a raising/lowering operation unit 17 for raising or lowering the plurality of slats 2 and a tilting operation unit 18 for tilting the plurality of slats 2.

As illustrated in FIG. 1, FIG. 6A, and FIG. 6B, the raising/lowering operation unit 17 includes a plurality of raising/lowering cords 19. The plurality of raising/lowering cords 19 are disposed so as to be parallel to the longitudinal cords 15a and 15b constituting the ladder cords 12. In addition, the lower end portions of the plurality of raising/lowering cords 19 are attached to the raising/lowering bar 14 in a state in which the plurality of raising/lowering cords 19 penetrate through aperture portions 20 formed in the slats 2.

The upper end sides of the plurality of raising/lowering cords 19 are wound inside the anchor box 13 and are pulled out through a window portion 21 provided in one side of the anchor box 13. The raising/lowering cords 19 pulled out through the window portion 21 are coupled to one end of an operation cord 22. The other end of the operation cord 22 is attached to one end portion of the raising/lowering bar 14.

In the raising/lowering operation unit 17, when the operation cord 22 is pulled while the raising/lowering bar 14 is located at the lowermost position, the raising/lowering cords 19 are retracted into the anchor box 13. Thus, the plurality of slats 2 are raised along with the raising/lowering bar 14 while being placed on top of each other on the raising/lowering bar 14 sequentially from the lower side. The raising/lowering cords 19 are locked by a stopper (not illustrated) provided on an inner side of the window portion 21. Thus, the raising/lowering bar 14 can be locked at a desired height position. Conversely, when the locking of the raising/lowering cords 19 by the stopper is cancelled, the raising/lowering bar 14 can be lowered with its own weight. Thus, the raising/lowering bar 14 can be replaced to the lowermost position.

As illustrated in FIG. 1, the tilting operation unit 18 includes an operation lever 23 provided on one side of the anchor box 13. The operation lever 23 is attached so that the operation lever 23 can freely pivot about the axis. In the tilting operation unit 18, as the operation lever 23 is pivoted about the axis, the longitudinal cords 15a and 15b constituting the ladder cords 12 illustrated in FIG. 6A can be moved in mutually opposite directions along the up-down direction. Thus, the plurality of slats 2 can be tilted in synchronization with one another between a state in which the space between the slats 2 is open as illustrated in FIG. 6A and a state in which the space between the slats 2 is closed as illustrated in FIG. 6B.

The blind 1 having such a configuration as described above is disposed while being suspended from the upper portion of a window pane or the like with the plurality of slats 2 opposing the inner surface of the window pane. In addition, the daylighting region 5 is disposed with the daylighting portions 42 in the daylighting slats 4 opposing the window pane.

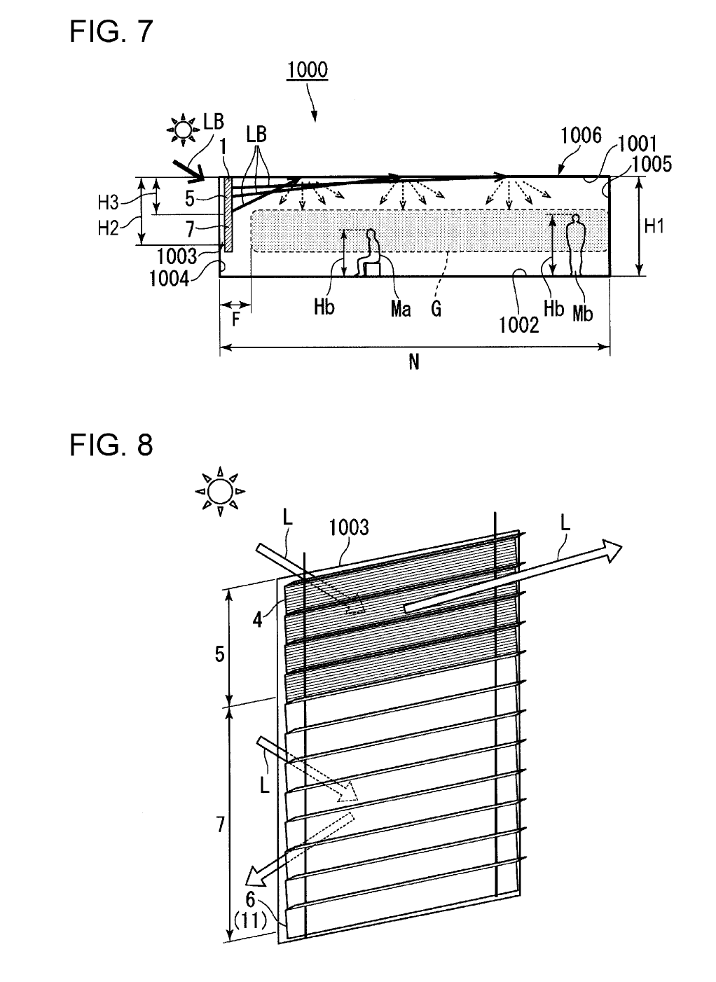

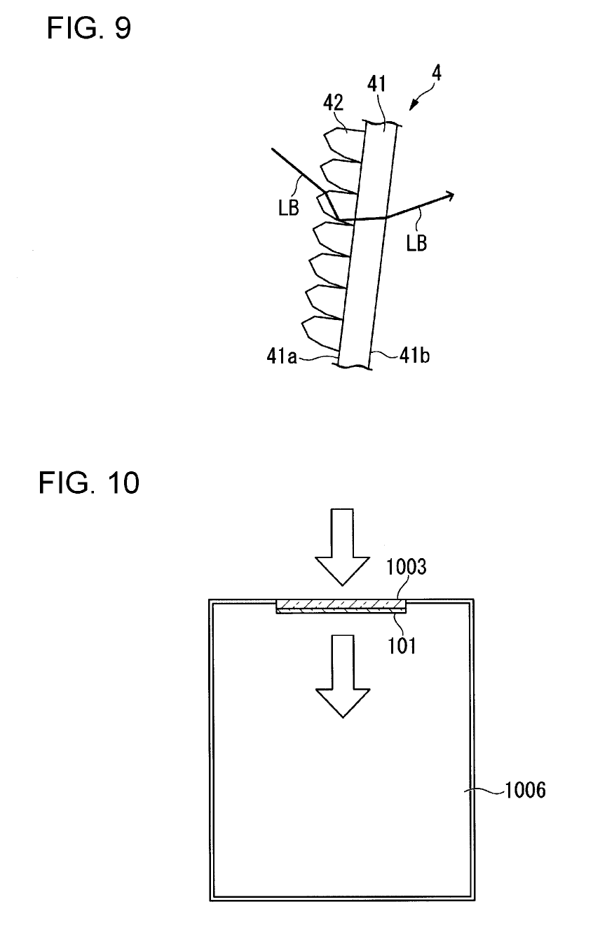

Now, functions of the daylighting region 5 and the shading region 7 of the blind 1 will be described with the use of a room model 1000 illustrated in FIG. 7. FIG. 7 is a schematic diagram illustrating an example of the room model 1000 in which the blind 1 is installed. FIG. 8 is a perspective view for describing the functions of the daylighting region and the shading region of the blind. FIG. 9 is an illustration for describing the daylighting function served by the daylighting slats.

The room model 1000 is a model simulating the use of the blind 1 in an office, for example. Specifically, the room model 1000 illustrated in FIG. 7 simulates a case in which outside light LB enters into a room interior 1006 obliquely from the above through a window pane 1003. The room interior 1006 is enclosed by a ceiling 1001, a floor 1002, a front side wall 1004 in which the window pane 1003 is attached, and a back side wall 1005 that opposes the front side wall 1004. The blind 1 is disposed so as to oppose the inner surface of the window pane 1003.

In the room model 1000, a heightwise dimension (a dimension from the ceiling 1001 to the floor 1002) H1 of the room interior 1006 is 2.7 m, a longitudinal dimension H2 of the window pane 1003 is 1.8 m from the ceiling 1001, a longitudinal dimension H3 of the daylighting region 5 is 0.6 in from the ceiling 1001, and a depthwise dimension (a dimension from the front side wall 1004 to the back side wall 1005) N of the room interior 1006 is 16 m.

In the room model 1000, there are a person Ma sitting on a chair toward the center portion of the room interior 1006 and a person Mb standing on the floor 1002 in the back of the room interior 1006. The height Ha of the eyes of the person Ma sitting on the chair is 0.8 m from the floor 1002, and the height Hb of the eyes of the person Mb standing on the floor 1002 is 1.8 m from the floor 1002.

A region (hereinafter, referred to as a glare region) G in which the persons Ma and Mb in the room interior 1006 experience glare is a range of the heights Ha and Hb of the eyes of the persons Ma and Mb, respectively, inside the room. In addition, the vicinity of the window pane 1003 in the room interior 1006 is a region F that is irradiated directly with outside light LB incoming primarily through the window pane 1003. This region F is a range of 1 m from the front side wall 1004. Therefore, the glare region G is a range defined by the height range of 0.8 m to 1.8 m from the floor 1002 and by the back side wall 1005 and a position 1 m away from the front side wall 1004 excluding the region F.

As illustrated in FIG. 8 and FIG. 9, in the daylighting region 5, the light LB that is incident on one surface of each daylighting slat 4 obliquely from the above and enters thereinto exits to the outside from the other surface of the daylighting slat 4 obliquely upward. Specifically, as illustrated in FIG. 9, in each daylighting slat 4, the light that is incident of the daylighting slat 4 is reflected inside the daylighting portion 42 and then exits from the second surface 41b of the substrate 41 as the light LB traveling toward the ceiling 1001 (FIG. 7).

Next, an occurrence state of glare light obtained when a conventional daylighting sheet that is directly affixed to a window pane is used and an occurrence state of glare light obtained when the blind according to an aspect of the present invention is used will be described.

First, the case in which the conventional daylighting sheet is used will be described.

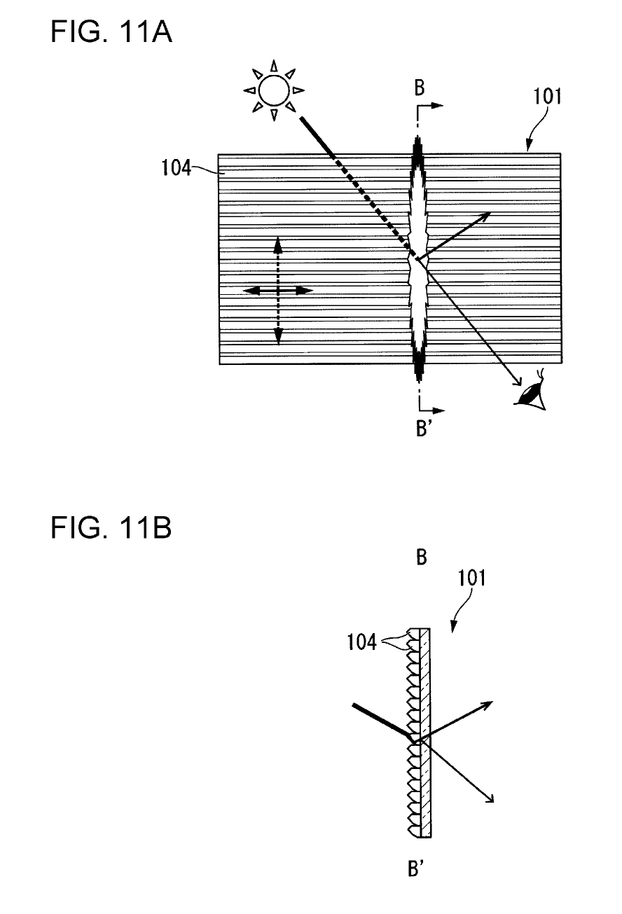

FIG. 10 illustrates a daylighting state into the room interior 1006 obtained when a conventional daylighting sheet 101 that is affixed to the window pane 1003 is used, as viewed from the ceiling. FIG. 11A illustrates a diffusion state (an occurrence state of glare light) of the light that exits from the conventional daylighting sheet, as viewed from the interior of the room. FIG. 11B is a sectional view taken along the B-B′ line indicated in FIG. 11A.

As illustrated in FIG. 10, the conventional daylighting sheet 101 that is affixed directly to the window pane 1003 includes a plurality of daylighting portions 104 that extend in the right-left direction of the window pane 1003 (FIG. 11A), and the plurality of daylighting portions 104 are arrayed in the up-down direction of the window pane 1003 (FIG. 11B).

Light incident on such a conventional daylighting sheet 101 is diffused in a direction intersecting the direction in which the daylighting portions 104 extend, that is, diffused in the up-down direction of the window pane 1003 by microstructures in the plurality of daylighting portions 104 and exits into the room interior 1006. At this point, little light is diffused in the direction in which the daylighting portions 104 extend. Thus, the glare light is stretched in the up-down direction at a position connecting the sun and the line of sights of a person inside the room. Due to such characteristics of the daylighting sheet 101, the glare light appears as a single longitudinal line and is recognized by the person in the room interior 1006. The positional relationship between the person in the room interior 1006 and the sun varies depending on the position of that person. Thus, although the location where the glare appears on the daylighting sheet 101 varies, the glare is constantly recognized. Such glare light gives a sense of discomfort to the person in the room interior 1006.

Next, the case in which the blind according to an aspect of the present invention is used will be described.

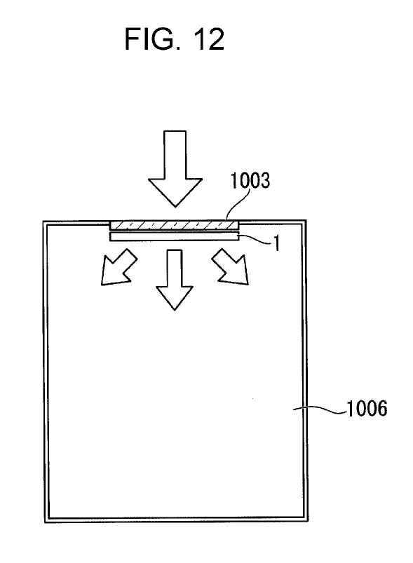

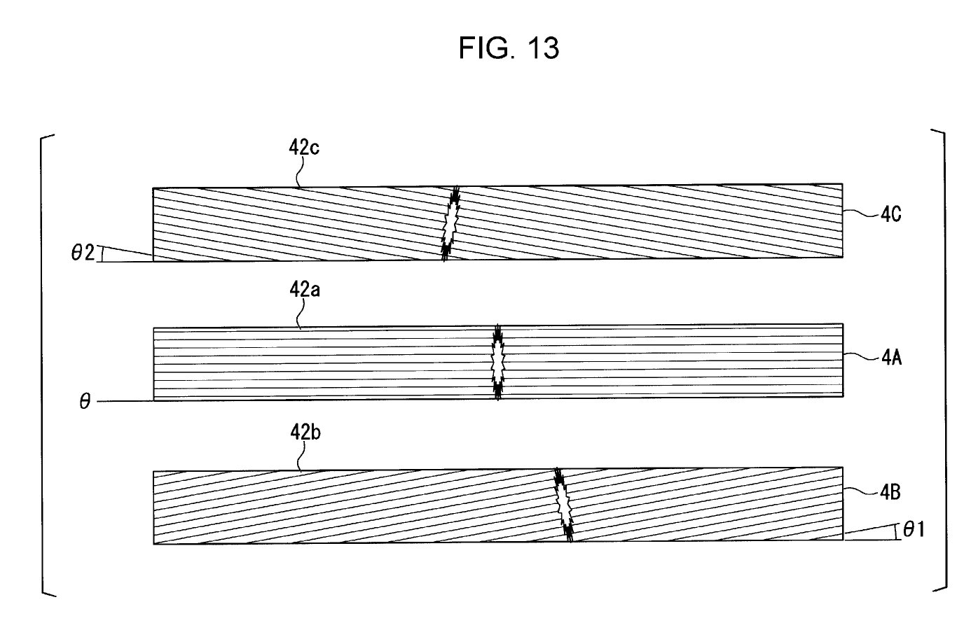

FIG. 12 illustrates a daylighting state into the room in which the blind according to an aspect of the present invention is installed, as viewed from the ceiling. FIG. 13 illustrates a diffusion state (an occurrence state of glare light) of the light that exits from the blind according to an aspect of the present invention, as viewed from the interior of the room.

As illustrated in FIG. 12, the blind 1 according to an aspect of the present invention is installed on the ceiling or the like in the vicinity of the window pane 1003. As described above, the blind 1 illustrated in FIG. 1 includes the plurality of slats 2 that extend in the right-left direction of the window pane 1003, and the plurality of slats 2 are arrayed in the up-down direction of the window pane 1003. Light incident on the three types of daylighting slats 4A, 4B, and 4C (FIG. 13) constituting the daylighting region 5, among the large number of slats 2 constituting the blind 1, exits toward mutually different regions in the right-left direction within the room due to the microstructures of the daylighting slats 4A, 4B, and 4C.

As illustrated in FIG. 13, in the daylighting slats 4A, 4B, and 4C, the directions in which the daylighting portions 42a, 42b, and 42c extend (the angles of inclination relative to the edge sides) as viewed from the above differ from one another. The light is not diffused in the directions in which the daylighting portions 42a, 42b, and 42c extend but diffused in the directions in which the daylighting portions 42a, 42b, and 42c are arrayed.

Therefore, the light is diffused in the up-down direction of the window pane 1003 in the daylighting slat 4A in which the angle of inclination of the daylighting portions 42a is 0°. Meanwhile, in the daylighting slat 4B in which the angle of inclination of the daylighting portions 42b is 10°, the light is stretched in the direction intersecting the direction in which the inclined daylighting portions 42b extend, that is, stretched in the angular direction inclined at +10° relative to the up-down direction of the window pane 1003. Furthermore, in the daylighting slat 4C in which the angle of inclination of the daylighting portions 42c is −10°, the light is stretched in the direction intersecting the direction in which the inclined daylighting portions 42c extend, that is, stretched in the angular direction inclined at −10° relative to the up-down direction of the window pane 1003.

As illustrated in FIG. 12, of the sunlight that enters the room interior 1006, the light incident on the daylighting region 5 of the blind 1 described above exits in mutually different directions in the right-left direction of the window pane 1003 due to the microstructures of the three types of daylighting slats 4 (the daylighting slats 4A, 4B, and 4C: FIG. 13). In other words, light exits toward the back of the room interior 1006 from the daylighting slat 4A, light exits toward the side wall located at one side in the right-left direction of the window pane 1003 from the daylighting slat 4B, and light exits toward the side wall located at the other side in the right-left direction of the window pane 1003 from the daylighting slat 4C. In this manner, in each of the daylighting slats 4B and 4C having the daylighting portions 42b and 42c, respectively, that are inclined in mutually different directions relative to the direction in which the daylighting slats 4 extend, light exits at an angle into a predetermined direction, and thus the amount of light that exits in the right-left direction in the room can be increased without providing a diffuser.

As described above, instead of constituting a blind by the daylighting slats 4A alone, the daylighting slats 4B and 4C having the daylighting portions 42b and 42c, respectively, that are inclined at predetermined angles relative to the direction in which the daylighting slats 4 extend are also provided as in the blind 1 according to the present embodiment. Thus, the location of a straight line of glare light varies among the daylighting slats 4 when the window is viewed from the room interior 1006. Therefore, an effect of reducing the glare light that directly hits the eyes of a person in the room interior 1006 depending on the location of that person can be expected.

### Modifications of Daylighting Slat

Now, modifications of the daylighting slat will be described.

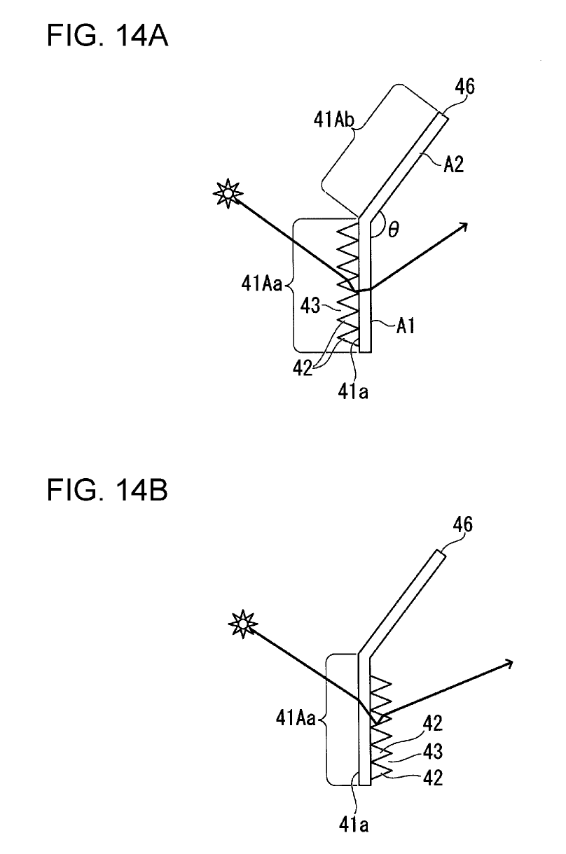

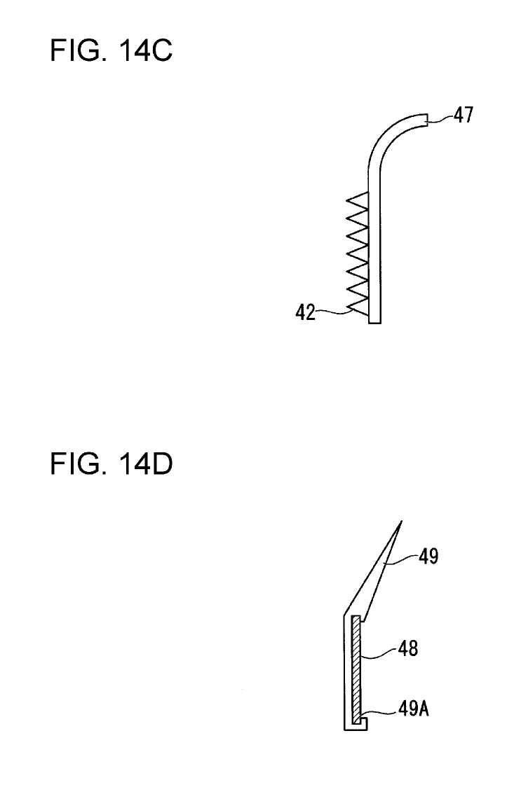

FIG. 14A to FIG. 14D are sectional views illustrating modifications of the daylighting slat, and the shapes of the substrates differ from one another.

As illustrated in FIG. 14A, a substrate 46 has a shape that is bent or curved along a section perpendicular to the lengthwise direction. The substrate 46 includes a first portion A1 in which a first region 41Aa is provided on the first surface 41a and a second portion A2 in which a second region 41Ab is provided on the first surface 41a. The substrate 46 is bent along a center line parallel to the lengthwise direction of the substrate 46 at a boundary between the first portion A1 in which the plurality of daylighting portions 42 are provided and the second portion A2 in which no daylighting portion 42 is provided.

An angle θ formed by the first portion A1 and the second portion A2 constituting the substrate 46 is set as appropriate in accordance with the shape of the daylighting portions 42 formed in the first region 41Aa.

In FIG. 14A, the daylighting portions 42 are formed on the side toward the window pane, but this is not a limiting example. It suffices that the daylighting portions 42 be formed in the first region 41Aa that includes a surface perpendicular to the window pane 1003, and thus the daylighting portions 42 may be formed on the side toward the room interior, as illustrated in FIG. 14B. In this case, it is preferable that the difference in the refractive index between the daylighting portions 42 and the gap portions 43 be adjusted as appropriate so that the daylighting portions 42 do not condense the light. In this case, the first surface 41a on which the daylighting portions 42 are provided is served by the surface opposite to that in the case illustrated in FIG. 14A.

In addition, instead of using a bent substrate, a substrate 47 that is curved at one end side, as illustrated in FIG. 14C, may be used.

Furthermore, as illustrated in FIG. 14D, a daylighting slat formed by embedding a daylighting sheet 48 in which a plurality of daylighting portions are formed on one surface of a film into a substrate 49 having a groove portion 49A formed by cutting out a portion of the substrate 49 may be employed. At this point, the daylighting sheet 48 may be installed such that the daylighting portions face the window, or the daylighting sheet 48 may be installed such that the daylighting portions 42 face the room interior.

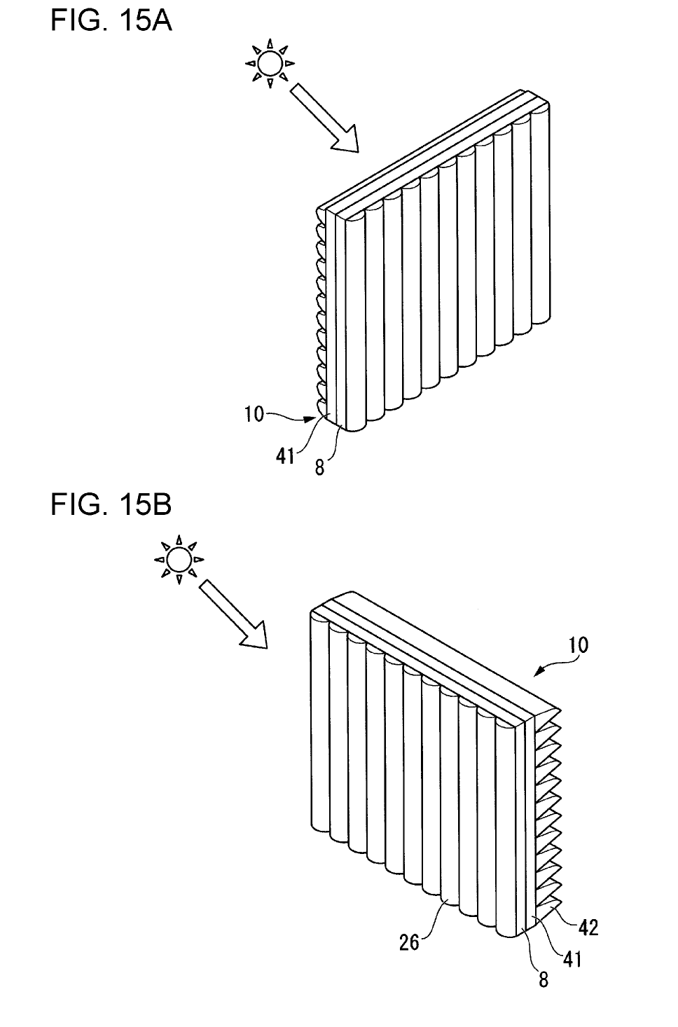

FIG. 15A and FIG. 15B are sectional views illustrating another modification of a daylighting slat and illustrate a structure of a daylighting slat to which a light diffusing function has been added.

As in a daylighting slat illustrated in FIG. 15A, the configuration may be such that the daylighting sheet 10 is provided on one surface 8a of the slat main body 8 and a light diffusing member 26 is provided on the other side 8b. As the light diffusing member 26, for example, an isotropically diffusing member in which a light diffusing layer in which spherical particulates of approximately several hundreds to several micrometers are dispersed in a resin is formed on a substrate can be used. When the daylighting sheet 10 includes the daylighting portions 42 that are inclined relative to the edge side 41d of the substrate 41, the light diffusing effect in the right-left direction of the window can be obtained due to the inclination of the daylighting portions 42, and thus an isotropically diffusing structure may be added. Alternatively, when the light is to be diffused in the right-left direction of the window, an anisotropic light diffusing structure, such as a lenticular lens, may be added.

As illustrated in FIG. 15B, the light diffusing member 26 may be installed so as to face the window pane.

### Second Embodiment

Next, a configuration of a roll screen serving as a second embodiment of the present invention will be described.

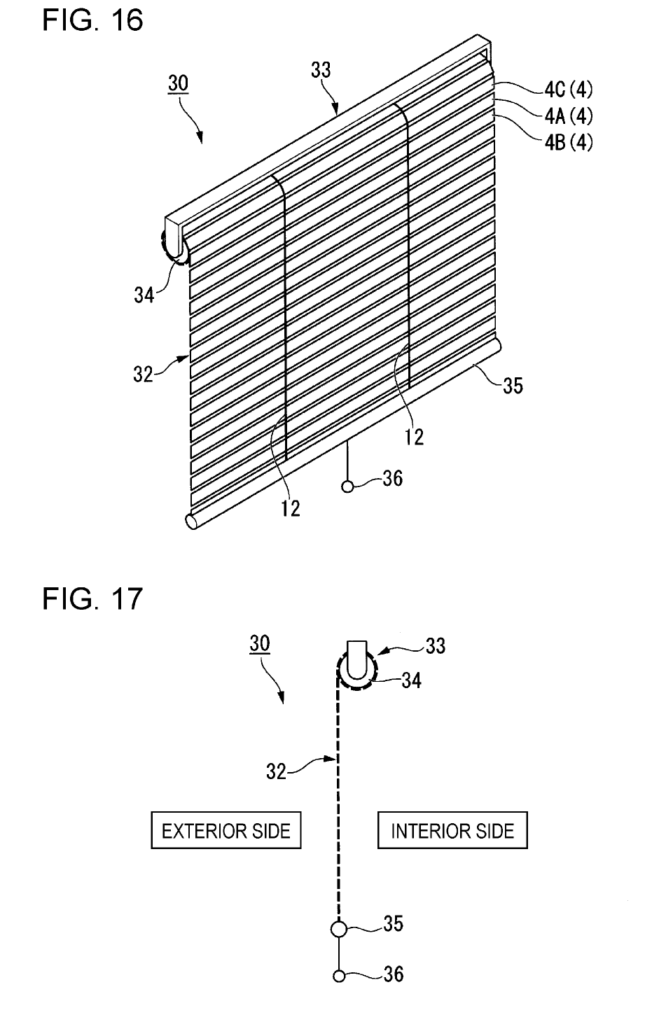

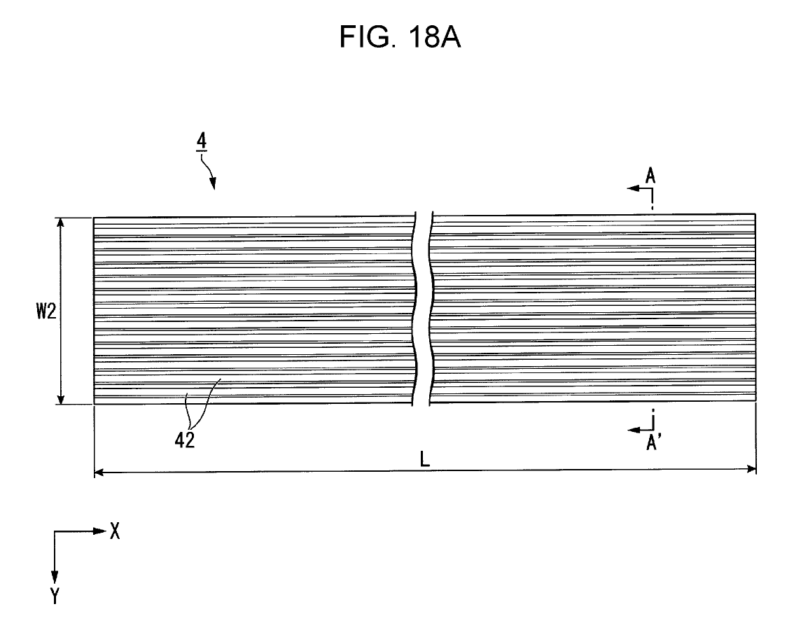

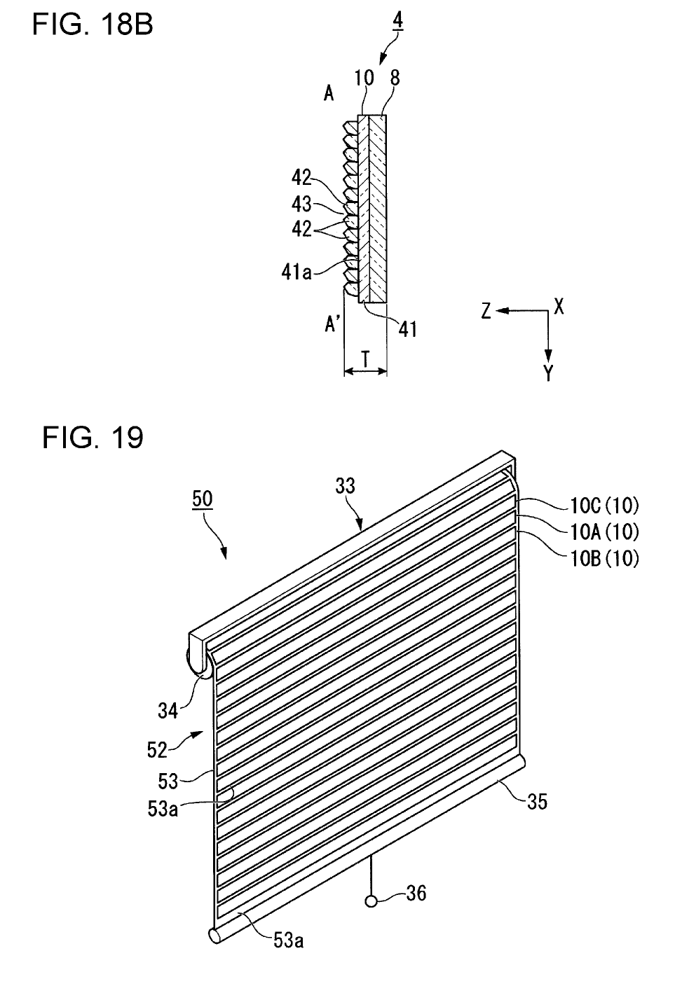

FIG. 16 is a perspective view illustrating an overall configuration of a roll screen (a daylighting apparatus) according to the second embodiment. FIG. 17 is a side view illustrating an overall configuration of the roll screen according to the second embodiment. FIG. 18A and FIG. 18B illustrate a configuration of a daylighting slat according to the second embodiment.

The basic configuration of a daylighting slat 4 in a roll screen 30 according to the present embodiment described hereinafter is substantially the same as that of the first embodiment described above. Thus, in the following descriptions, differences will be described in detail, and descriptions of common portions will be omitted. In addition, in each of the drawings referred to in the descriptions, constituent elements common to those illustrated in FIG. 1 to FIG. 8 are given identical reference characters.

As illustrated in FIG. 16 and FIG. 17, the roll screen (the daylighting apparatus) 30 according to the present embodiment includes a daylighting screen 32 and a take-up mechanism 33 that supports the daylighting screen 32 such that the daylighting screen 32 can be taken up freely.

The take-up mechanism 33 includes a winding core 34 attached along the upper end portion of the daylighting screen 32, a lower pipe 35 attached along the lower end portion of the daylighting screen 32, and a pulling cord 36 attached at the center in the lower end portion of the daylighting screen 32.

The daylighting screen 32 includes a plurality of daylighting slats (daylighting members) 4 (4A, 4B, and 4C) of the three types described above and a pair of ladder cords 12 and 12 that couple the plurality of daylighting slats 4A, 4B, and 4C. The plurality of daylighting slats 4 are disposed in a repeated manner in the order of the daylighting slats 4C, 4A, and 4B in the up-down direction and are coupled by the ladder cords 12 and 12 at two portions in the lengthwise direction.

As illustrated in FIG. 18A and 18B, each of the daylighting slats 4 has a dimension L in the lengthwise direction (the X-direction) of approximately 1000 mm and a thickness T of 1 mm The daylighting slats 4 according to the present embodiment have a smaller dimension than those of the foregoing embodiment. Specifically, the slat width (the dimension in the widthwise direction (the Y-direction)) W2 is approximately 6 mm.

The take-up mechanism 33 is of a pull-cord type and can lock the daylighting screen 32 at a position to which the daylighting screen 32 has been pulled out or cancel the locking as the daylighting screen 32 is further pulled out by pulling the pulling cord 36 to allow the winding core 34 to automatically take up the daylighting screen 32.

The take-up mechanism 33 is not limited to a pull-cord type, and a take-up mechanism of a chain type in which the winding core 34 is rotated by a chain, an automatic take-up mechanism that rotates the winding core 34 with a motor, or the like may be used.

The roll screen 30 having the configuration as described above is used in the following state: the winding core 34 is fixed to the upper portion of a window pane, in this state the daylighting screen 32 coupled to the winding core 34 is pulled out with the pulling cord 36, and the daylighting portions of the daylighting screen 32 are made to oppose the inner surface of the window pane.

With the roll screen 30 according to the present embodiment, the slat width W2 of the daylighting slats 4 can be made smaller than that in the foregoing embodiment, and thus the intensity of the glare light that exits from each of the daylighting slats 4 can be reduced. Thus, the bright spot from each of the daylighting slats 4 becomes smaller, and the glare that a person in a room interior experiences can be reduced.

### Third Embodiment

Next, a roll screen (a daylighting apparatus) serving as a third embodiment of the present invention will be described.

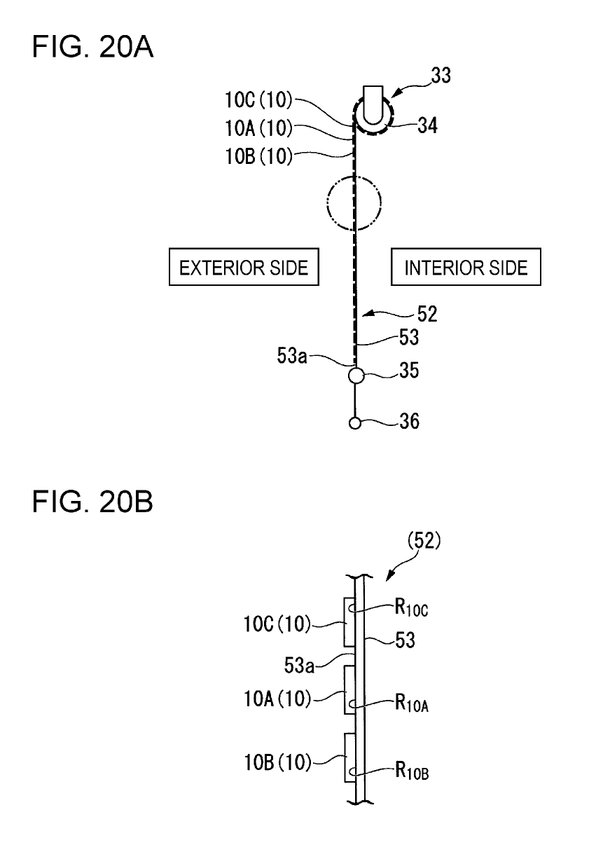

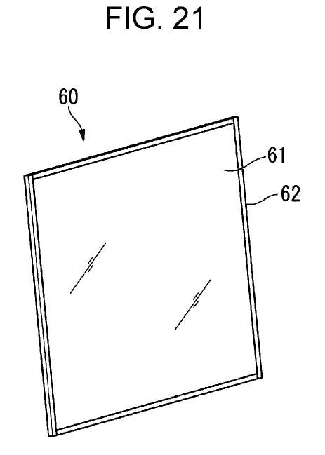

FIG. 19 is a perspective view illustrating an overall configuration of a roll screen (a daylighting apparatus) according to the third embodiment. FIG. 20A is a side view illustrating an overall configuration of the roll screen according to the third embodiment, and FIG. 20B is an enlarged sectional view of a portion enclosed by a dashed-dotted circle indicated in FIG. 20A.

The basic configuration of a daylighting member in the roll screen according to the present embodiment described hereinafter is substantially the same as that of the first embodiment described above. Thus, in the following descriptions, differences will be described in detail, and descriptions of common portions will be omitted. In addition, in each of the drawings referred to in the descriptions, constituent elements common to those illustrated in FIG. 1 to FIG. 8 are given identical reference characters.

As illustrated in FIG. 19, a roll screen (a daylighting apparatus) 50 according to the present embodiment includes a daylighting screen 52 and a take-up mechanism 33 that supports the daylighting screen 52 such that the daylighting screen 52 can be taken up freely.

The daylighting screen 52 according to the present embodiment includes a screen main body 53 connected at one end side to a winding core 34 and having a light transmitting property and a plurality of daylighting sheets (daylighting members) 10 provided on one surface 53a of the screen main body 53. Regions for disposing the daylighting sheets 10 of different types are set on the one surface 53a of the screen main body 53.

As the screen main body 53, aside from a transparent film, a cloth, a design film, or the like may be used. In addition, a substrate containing a UV absorber or an infrared absorber may be used.

As illustrated in FIG. 20A and 20B, the plurality of daylighting sheets 10 are daylighting sheets 10A, 10B, and 10C having mutually different optical characteristics, disposed in the up-down direction in the order of the daylighting sheets 10C, 10A, and 10B in the up-down direction, and are affixed to the above-described regions (a first region, a second region, and a third region) R_{10A}, R_{10B}, and R_{10C} set on the one surface 53a. The daylighting sheets 10C, 10A, and 10B are affixed to the one surface 53a of the screen main body 53 with a bonding material or the like (not illustrated).

The daylighting sheets 10C, 10A, and 10B each have a dimension in the lengthwise direction of approximately 1000 mm, a dimension in the widthwise direction of approximately 6 mm, and a thickness of 0.3 mm.

The roll screen 50 having the configuration as described above is used in the following state: the winding core 34 is fixed to the upper portion of a window pane, in this state the daylighting screen 52 coupled to the winding core 34 is pulled out with a pulling cord 36, and the daylighting sheets 10 are made to oppose the inner surface of the window pane.

With the roll screen 50 according to the present embodiment, the sheet width (the dimension in the widthwise direction) of each daylighting sheet 10 can be made smaller than that of the first embodiment, and thus the intensity of the glare light that exits from each of the daylighting sheets 10 can be reduced. Thus, the bright spot from each of the daylighting sheets 10 becomes smaller, and the glare that a person in a room interior experiences can be reduced.

### Fourth Embodiment

Next, a daylighting panel serving as a fourth embodiment of the present invention will be described.

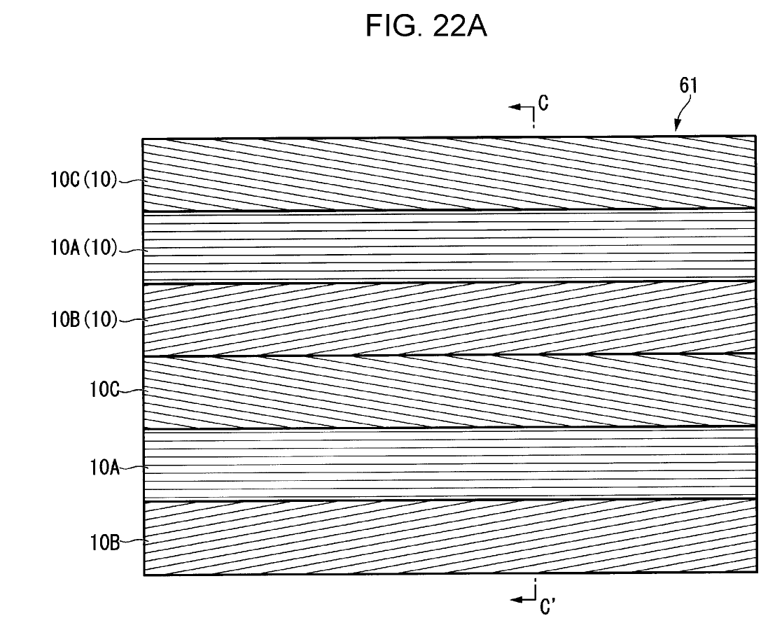

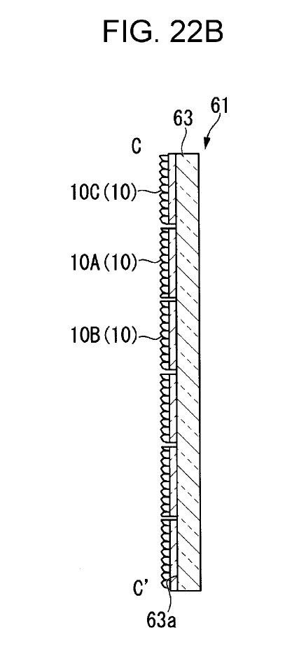

FIG. 21 is a perspective view illustrating an overall configuration of a daylighting panel (a daylighting apparatus) according to the fourth embodiment. FIG. 22A is a front view illustrating a schematic configuration of a daylighting panel main body according to the fourth embodiment, and FIG. 22B is a sectional view taken along the C-C′ line indicated in FIG. 22A.

The basic configuration of a daylighting member in the daylighting panel according to the present embodiment described hereinafter is substantially the same as that of the first embodiment described above. Thus, in the following descriptions, differences will be described in detail, and descriptions of common portions will be omitted. In addition, in each of the drawings referred to in the descriptions, constituent elements common to those illustrated in FIG. 1 to FIG. 8 are given identical reference characters.

As illustrated in FIG. 21, a daylighting panel (a daylighting apparatus) 60 according to the present embodiment includes a daylighting panel main body 61 and a frame 62 that supports the daylighting panel main body 61 at the outer periphery thereof.

The frame 62 is constituted by a frame member having a rectangular shape as viewed from the above and includes a groove portion (not illustrated) into which the outer peripheral portion of the daylighting panel main body 61 is inserted. The frame 62 is made of an aluminum alloy, a resin, or the like.

As illustrated in FIG. 22A and FIG. 22B, the daylighting panel main body 61 includes a transparent substrate 63 having a rectangular shape as viewed from the above and a plurality of daylighting sheets 10 (daylighting sheets 10A, 10B, and 10C) provided on one surface 63a of the transparent substrate 63. The transparent substrate 63 is constituted by glass, a transparent resin substrate, or the like.

The daylighting sheets 10 each have a sheet width (a dimension in the widthwise direction) of 25 mm, but this is not a limiting example. The daylighting sheets 10 may have any sheet width that can make an operation of affixing the daylighting sheets 10 to the transparent substrate 63 easier.

By affixing the plurality of daylighting sheets 10A, 10B, and 10C in which the directions in which daylighting portions 42 extend differ from one another in a large number onto the transparent substrate 63, the glare light that exits from each of the daylighting sheets 10 can be diffused in the right-left direction in the room, and the bright spot on each of the daylighting sheets 10 can be made smaller.

The daylighting panel 60 according to the present embodiment may be used while being directly embedded into a window frame or may be fixed to a wall surface around a window pane. Alternatively, the daylighting panel 60 may be suspended from the room ceiling near the window pane.

### Modifications of Daylighting Slat

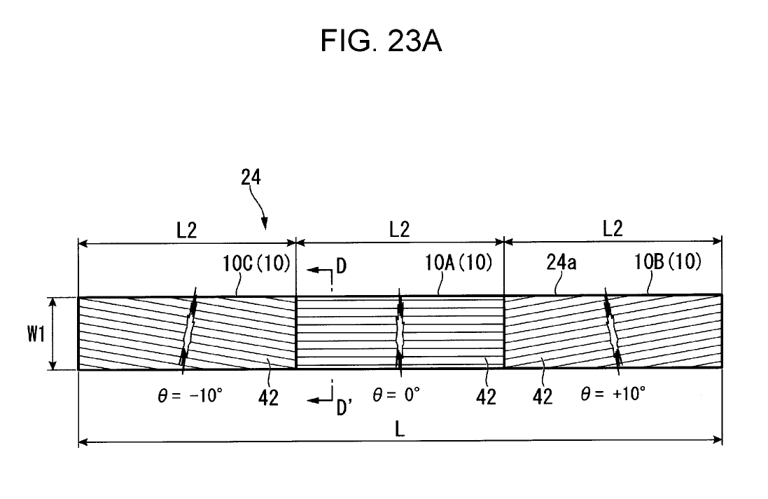

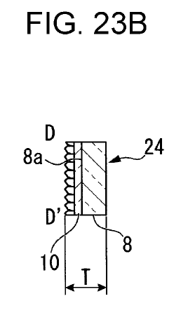

Next, as a modification of the daylighting slat, a configuration of a daylighting slat as illustrated in FIG. 23A and FIG. 23B will be described.

FIG. 23A is a plan view illustrating a schematic configuration of a daylighting slat according to a modification constituting a blind, and FIG. 23B is a sectional view of FIG. 23A.

The basic configuration of a daylighting member used in the daylighting slat described hereinafter is substantially the same as that of the first embodiment described above. Thus, in the following descriptions, differences will be described in detail, and descriptions of common portions will be omitted. In addition, in each of the drawings referred to in the descriptions, constituent elements common to those illustrated in FIG. 1 to FIG. 8 are given identical reference characters.

As illustrated in FIG. 23A and FIG. 23B, a daylighting slat (a daylighting member) 24 according to the present embodiment includes a slat main body 8 and a plurality of daylighting sheets 10A, 10B, and 10C provided on one surface 8a of the slat main body 8.

In the present embodiment, one each of the three types of daylighting sheets 10A, 10B, and 10C is tiled on each slat main body 8.

The daylighting slat 24 according to the present embodiment has a dimension L in the lengthwise direction of approximately 1000 mm, a dimension W1 in the widthwise direction of approximately 25 mm, and a thickness T of 1 mm. A dimension L2 of each of the daylighting sheets 10A, 10B, and 10C in the lengthwise direction is set as appropriate in accordance with the size of the daylighting slat 24, and the daylighting sheets 10A, 10B, and 10C have the same dimension. Herein, the dimension L2 in the lengthwise direction is approximately 330 mm.

As illustrated in FIG. 23A, among the daylighting sheets 10A, 10B, and 10C, the daylighting sheet 10A in which a plurality of daylighting portions 42 have an equal dimension in the lengthwise direction and are arrayed so as to be parallel to one another is disposed at the middle of the daylighting slat 24 in the lengthwise direction, and the daylighting sheets 10B and 10C are disposed on the respective sides of the daylighting sheet 10A. Here, when the daylighting sheets 10B and 10C are tiled, it is preferable that the daylighting sheets 10B and 10C be disposed such that the daylighting portions 42 therein are inclined upward toward an upper end 24a as the distance to the corresponding end sides of the daylighting slat 24 in the lengthwise direction decreases.

In this manner, as the three types of daylighting sheets 10A, 10B, and 10C are tiled on a single slat main body 8, light exits so as to spread toward the outer sides in the lengthwise direction of the daylighting slat 24, and the exit light can be diffused efficiently in the right-left direction of the window.

In the present embodiment, a configuration in which three types of daylighting sheets 10 are provided in a single daylighting slat 24 has been described, but this is not a limiting example, and a configuration may be such that two types of daylighting sheets 10 are affixed. The combination of the daylighting sheets 10 to be affixed onto the slat main body 8 can be set as appropriate.

In addition, when a blind is constituted, it is desirable that the daylighting slats 24 that are adjacent to each other in the up-down direction include different types of daylighting sheets 10. Thus, the glare light produced in each of the daylighting sheets 10 can be dispersed, and the bright spot thus becomes smaller.

In addition, a blind may be constituted by mixing a daylighting slat 24 in which three type of daylighting sheets 10 are affixed, a daylighting slat 24 in which two types of daylighting sheets 10 are affixed, and a daylighting slat 24 in which only one type of daylighting sheet 10 is affixed.

In addition, the sizes of the daylighting sheets 10A, 10B, and 10C to be affixed onto the slat main body 8 may be the same as one another, or the dimension in the lengthwise direction may differ among the daylighting sheets 10A, 10B, and 10C, for example.

### Modifications of Daylighting Apparatus

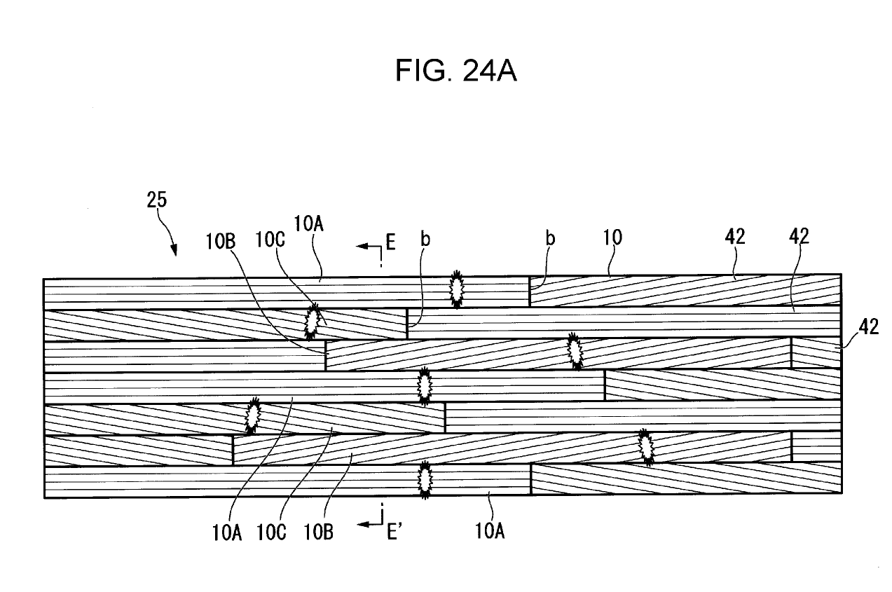

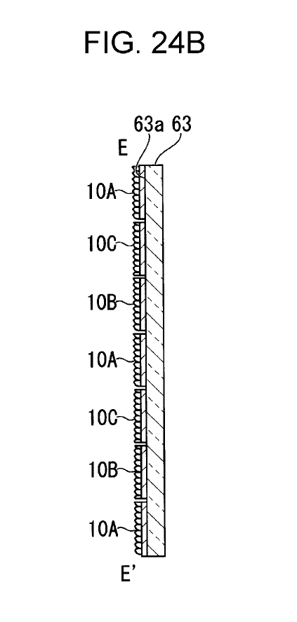

Next, as a modification of the daylighting apparatus according to an aspect of the present invention, a configuration of a daylighting panel as illustrated in FIG. 24A and FIG. 24B will be described.

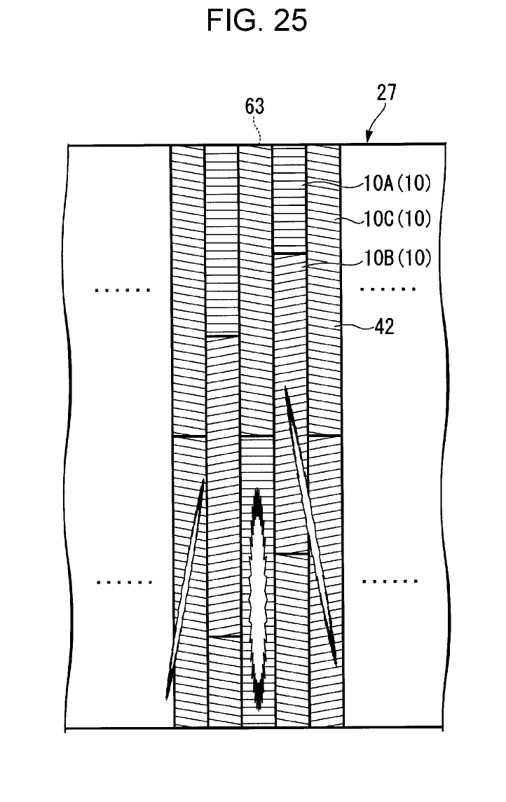

FIG. 24A is a plan view illustrating a schematic configuration of the daylighting panel, and FIG. 24B is a sectional view taken along the E-E line indicated in FIG. 24A. FIG. 25 is a plan view in which a plurality of daylighting members with their lengthwise direction extending in the up-down direction are tiled, serving as a comparative example.

The basic configuration of the daylighting panel according to the present embodiment described hereinafter is substantially the same as that of the fourth embodiment described above.

Thus, in the following descriptions, differences will be described in detail, and descriptions of common portions will be omitted. In addition, in each of the drawings referred to in the descriptions, constituent elements common to those in FIG. 21 to FIG. 22B are given identical reference characters.

As illustrated in FIG. 24A and FIG. 24B, a daylighting panel (a daylighting apparatus) 25 according to a modification is configured such that a plurality each of the three types of daylighting sheets 10A, 10B, and 10C are tiled in the up-down direction and the right-left direction on one surface 63a of a transparent substrate 63. Each of the daylighting sheets 10A, 10B, and 10C is disposed randomly on the transparent substrate 63. The daylighting sheets 10A, 10B, and 10C each have a dimension in the lengthwise direction of approximately no less than 500 mm and a dimension in the widthwise direction of approximately 25 mm. The dimensions of the daylighting sheets 10A, 10B, and 10C in the lengthwise direction vary depending on the position where the daylighting sheets 10A, 10B, and 10C are tiled on the transparent substrate 63.

The plurality of daylighting sheets 10A, 10B, and 10C are tiled such that the lengthwise direction of each is parallel to the lengthwise direction of the transparent substrate 63. Here, boundaries b between the daylighting sheets 10 that are adjacent to each other in the lengthwise direction of the transparent substrate 63 are kept from coinciding with one another in the widthwise direction of the transparent substrate 63.

With the configuration according to the present embodiment, various types of daylighting sheets 10 are disposed in a random manner, and the lengthwise direction of each daylighting sheet 10 matches the lengthwise direction of the transparent substrate 63. Thus, the glare light (the bright spot) that is stretched in the up-down direction in each of the daylighting sheets 10 can be made smaller. In other words, a plurality of daylighting portions 42 that extend in the same direction are present in a small number in the up-down direction, and the glare light is not stretched in the up-down direction to a great extent.

Thus, when a large number of daylighting sheets 10 are to be provided on a single transparent substrate 63, by tiling the daylighting sheets 10 such that the lengthwise direction of the daylighting sheets 10 is parallel to the lengthwise direction of the transparent substrate 63, the glare can be suppressed to a great extent.

In the present embodiment, the daylighting sheets 10A, 10B, and 10C are disposed randomly on the transparent substrate 63, but this is not a limiting example, and the daylighting sheets 10A, 10B, and 10C may be disposed in a regular pattern.

In addition, the tiling configuration of the daylighting sheets 10A, 10B, and 10C according to the modification described above is not limited to the daylighting panel according to the fourth embodiment and can also be applied to each of the roll screens according to the second embodiment and the third embodiment as appropriate. In addition, the tiling configuration can also be applied to the daylighting slat according to the first embodiment as appropriate.

As in a daylighting slat 27 illustrated in FIG. 25, the daylighting sheets 10A, 10B, and 10C may be tiled such that the lengthwise direction of each of the daylighting sheets 10A, 10B, and 10C is parallel to the widthwise direction of the transparent substrate 63. Even in this case, the glare light can be dispersed to a plurality of sites, and thus the intensity of the glare light can be reduced, as compared to a conventional daylighting slat in which a plurality of daylighting portions 42 are provided so as to be parallel to the lengthwise direction of the slat.

### Fifth Embodiment

Next, a daylighting apparatus according to a fifth embodiment of the present invention will be described.

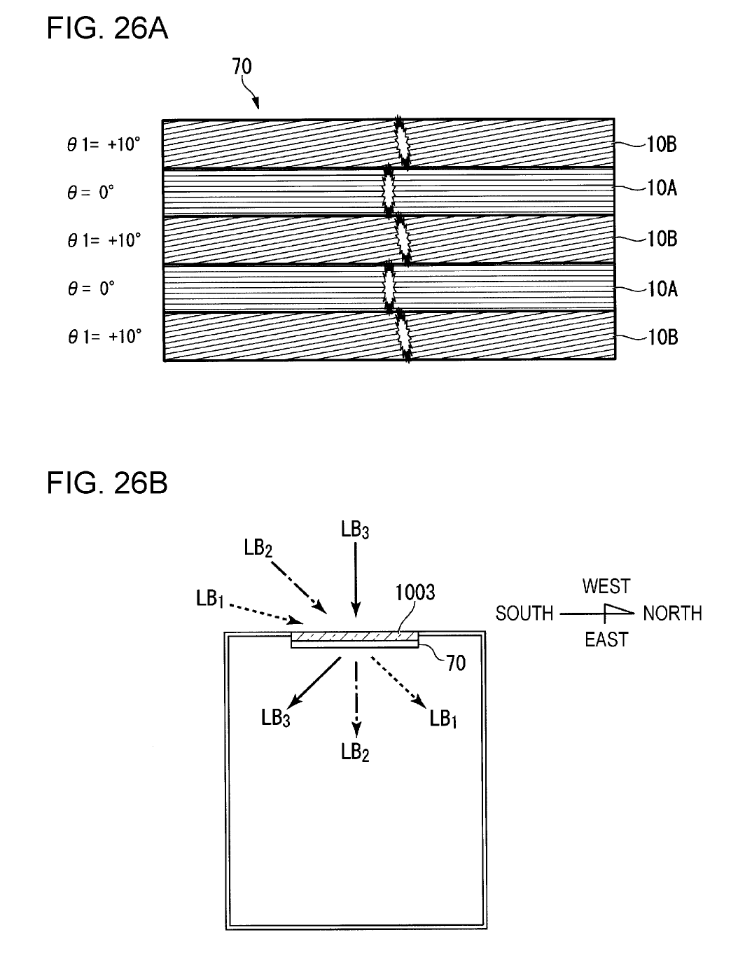

FIG. 26A is a front view illustrating a schematic configuration of the daylighting apparatus according to the fifth embodiment, and FIG. 26B is a daylighting image diagram obtained when the daylighting apparatus according to the fifth embodiment is installed at a window in a room.

The basic configuration of a daylighting member in the daylighting apparatus according to the present embodiment described hereinafter is substantially the same as that of the fourth embodiment described above. Thus, in the following descriptions, differences will be described in detail, and descriptions of common portions will be omitted. In addition, in each of the drawings referred to in the descriptions, constituent elements common to those illustrated in FIG. 21 to FIG. 22B are given identical reference characters.

As illustrated in FIG. 26A, a daylighting apparatus 70 according to the present embodiment includes two types of daylighting sheets 10A and 10B. In the daylighting sheet 10A, a plurality of daylighting portions 42 extend so as to be parallel to the direction in which the daylighting sheet extends. In the daylighting sheet 10B, a plurality of daylighting portions 42 are inclined at a first angle θ1 relative to the direction in which the daylighting sheet extends. These daylighting sheets 10A and 10B are disposed alternatingly in a repeated manner in the up-down direction of the daylighting apparatus 70.

The daylighting sheets 10B and 10B of the same configuration are disposed, respectively, at the upper and lower sides of the daylighting sheet 10A, and thus light exits from each of the daylighting sheets 10B in a specific direction relative to the direction of light that exits from the daylighting sheet 10A.

For example, as illustrated in FIG. 26B, when the daylighting apparatus 70 according to the present embodiment is installed on the inner side of a window facing west, light LB₁ incoming from the south side during daytime is refracted in a specific direction by the daylighting apparatus 70 (in particular, the daylighting sheets 10B) and exits toward the right wall portion (north) of the room interior. In addition, light LB₂ incoming from the southwest side is refracted in a specific direction by the daylighting apparatus 70 (in particular, the daylighting sheets 10B) and exits toward the back wall portion (east) of the room interior. Furthermore, light LB₃ incoming from the west side is refracted in a specific direction by the daylighting apparatus (in particular, the daylighting sheets 10B) 70 and exits toward the left wall portion (south) of the room interior.

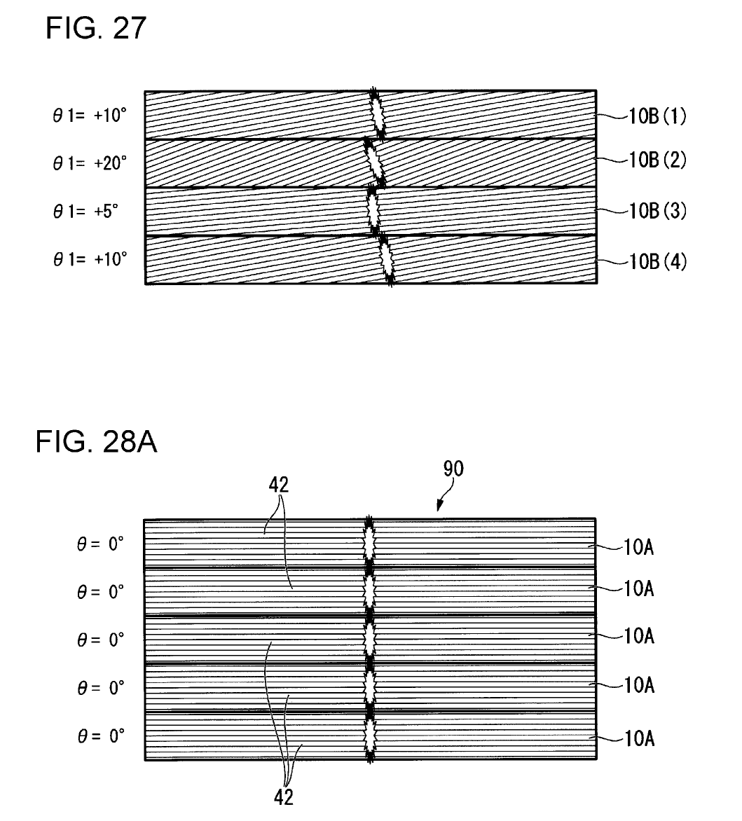

FIG. 27 illustrates a modification of the daylighting apparatus according to the fifth embodiment.

As in the daylighting apparatus illustrated in FIG. 27, a plurality of types of daylighting sheets 10B in which the angles of inclination of the daylighting portions 42 differ from one another may be provided. Herein, an example in which four types of daylighting sheets 10B(1), 10B(2), 10B(3), and 10B(4) are provided is illustrated.

In the daylighting sheet 10B(1), the plurality of daylighting portions 42 are inclined at a first angle θ1 of +10° relative to the direction in which the daylighting sheet extends.

In the daylighting sheet 10B(2), the plurality of daylighting portions 42 are inclined at a first angle θ1 of +20° relative to the direction in which the daylighting sheet extends.

In the daylighting sheet 10B(3), the plurality of daylighting portions 42 are inclined at a first angle θ1 of +5° relative to the direction in which the daylighting sheet extends.

In the daylighting sheet 10B(4), the plurality of daylighting portions 42 are inclined at a first angle θ1 of +10° relative to the direction in which the daylighting sheet extends.

In this manner, a configuration in which the daylighting sheet 10A in which the daylighting portions 42 extend so as to be parallel to the direction in which the daylighting sheet extends is not provided can also be employed.

The number of the types of daylighting sheets 10B to be used or the angle θ1 of inclination of the daylighting portions 42 in the daylighting sheets 10B can be modified as appropriate. The configuration may also be such that only a plurality of types of daylighting sheets 10C in which the daylighting portions 42 are inclined at mutually different angles θ2 of inclination are provided.

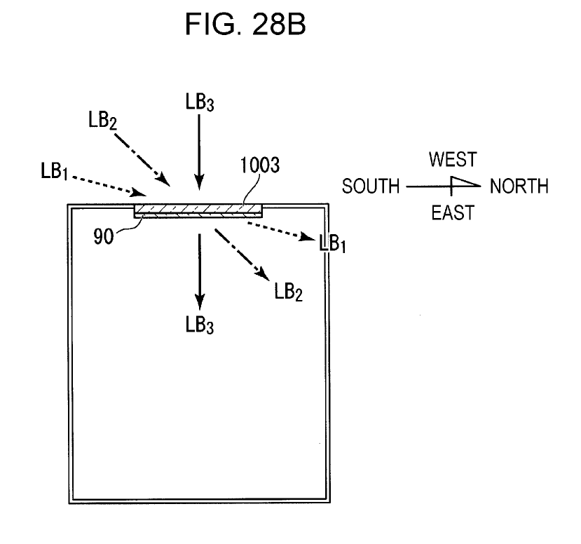

FIG. 28A is a front view illustrating a configuration of a conventional daylighting apparatus, and FIG. 28B is a daylighting image diagram obtained when the conventional daylighting apparatus is installed at a window in a room.

Meanwhile, as illustrated in FIG. 28A, in the case of a daylighting apparatus 90 that is constituted by only the daylighting sheets 10A, the inclination of the daylighting portions 42 in each of the daylighting sheets 10A is parallel (the angle θ of inclination is 0°) to the edge side of the daylighting sheets 10A, and thus light exits substantially linearly relative to the incident light.

In other words, as illustrated in FIG. 28B, light LB₁ incident on the daylighting apparatus 90 from the south side is transmitted through each daylighting sheet 10A and exits toward the right wall portion (north) of the room interior.

In addition, light LB₂ incoming from the southwest side is transmitted through the daylighting sheets 10A and exits toward the right wall portion (north) in the back of the room interior.

Furthermore, light LB₃ incoming from the west side is transmitted through each daylighting sheet 10A and exits toward the back wall portion (east) of the room interior.

In this manner, as compared to the daylighting apparatus 90 that is constituted by the daylighting sheets 10A alone, the daylighting apparatus 70 according to the present embodiment in which the daylighting sheets 10A and the daylighting sheets 10B are both provided can more efficiently diffuse and output the light in the right-left direction of the room interior.

In addition, in the present embodiment, as the two types, namely, the daylighting sheet 10A and the daylighting sheet 10B are provided, the direction in which a large number of daylighting portions 42 are inclined in the daylighting sheets 10B located at the upper and lower sides of the daylighting sheet 10A becomes constant, and the light can be made to exit in a predetermined direction. In this manner, by constituting the daylighting apparatus 70 by both the daylighting sheets 10A and the daylighting sheet 10B, a larger amount of light can be made to reach the back side of the room interior than the conventional daylighting apparatus 90 constituted by only the daylighting sheets 10A can.

The various combinations of the daylighting sheets that constitute the daylighting apparatus are not limited to those described above.

For example, the types of daylighting sheets to be combined may be modified in accordance with the orientation of a window at which the daylighting apparatus is installed. For example, a daylighting apparatus may be constituted by the daylighting sheets 10A and the daylighting sheets 10C, or a daylighting apparatus may be constituted by the daylighting sheets 10B and the daylighting sheets 10C.

In the present embodiment, a daylighting apparatus that is installed at a window facing west has been described, but a daylighting apparatus suitable for a window in any orientation can be constituted through combinations of the daylighting sheets.

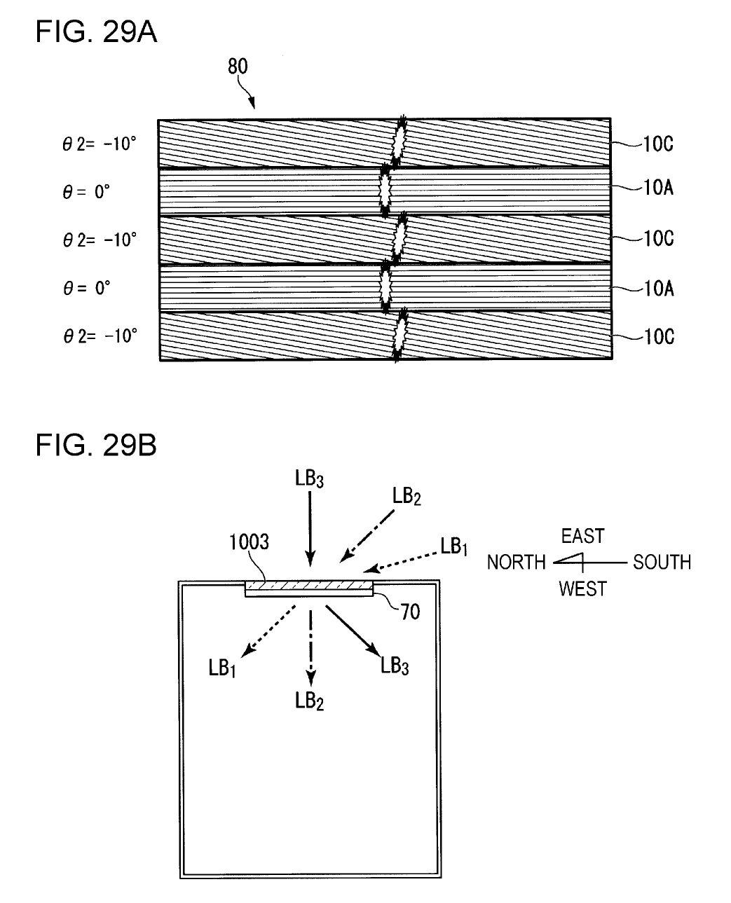

FIG. 29A illustrates a modification of the fifth embodiment, and FIG. 29B is a daylighting image diagram obtained when the daylighting apparatus according to the modification is installed at a window facing east.

As illustrated in FIG. 29A and FIG. 29B, as an example, a daylighting apparatus 80 suitable for a window facing east can be constituted by using the daylighting sheets 10A and the daylighting sheets 10C. In this case, the daylighting sheets 10A and 10C are disposed alternatingly in a repeated manner in the up-down direction.

Light LB₁ incoming from the south side during daytime is refracted in a specific direction by the daylighting apparatus 80 (in particular, the daylighting sheets 10C) and exits toward the left wall portion (north) of the room interior. In addition, light LB₂ incoming from the southeast side is refracted in a specific direction by the daylighting apparatus 80 (in particular, the daylighting sheets 10C) and exits toward the wall portion (west) in the back of the room interior. Furthermore, light LB₃ incoming from the east side is refracted in a specific direction by the daylighting apparatus (in particular, the daylighting sheets 10C) 80 and exits toward the right wall portion (south) of the room interior.

In addition, as another configuration example, a daylighting apparatus may be constituted by using a plurality of types of daylighting sheets in which the angles of inclination of the daylighting portions 42 differ from one another. For example, a daylighting apparatus may be constituted by respective five types of daylighting sheets in which each daylighting portion 42 is inclined at 0°, +5°, +10°, +15°, and +20°. The number of the types of daylighting sheets is not limited to five, and six or more types of daylighting sheets or less than five types of daylighting sheets may be provided. The angle of inclination of the daylighting portions 42 may be on the negative side.

In addition, the order in which the plurality of types of daylighting sheets are arrayed may be in the order of the angles or may be random.

In addition, the configuration of the daylighting panel according to the present embodiment described above can also be applied, as appropriate, to any of the embodiments of the blind, the roll screen, and the daylighting panel described above.

### Method for Manufacturing Daylighting Sheet

Next, a method for manufacturing a daylighting sheet will be described.

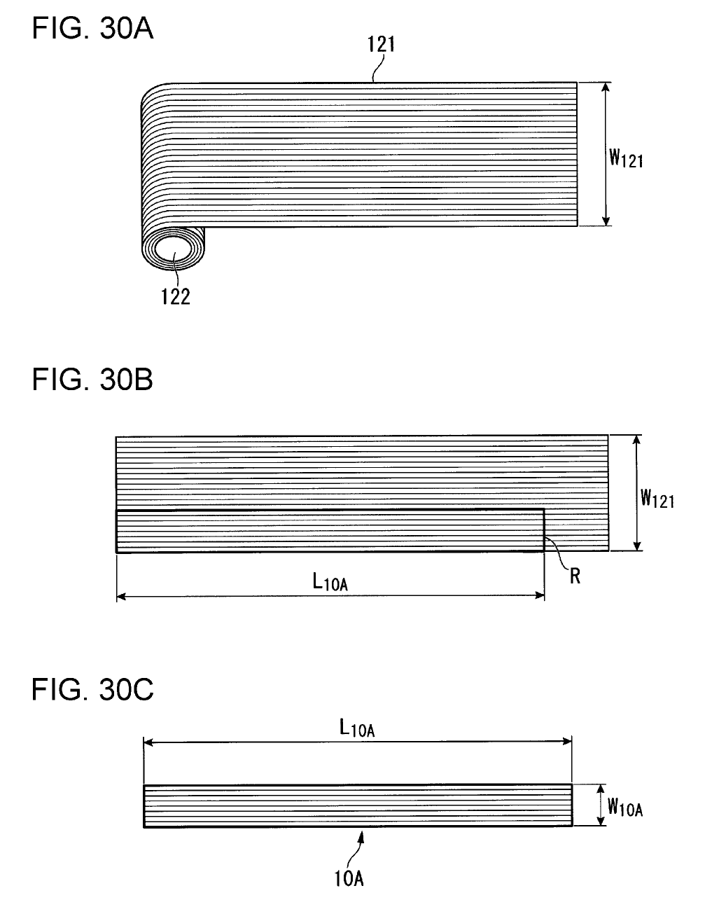

FIG. 30A and FIG. 30B are illustrations for describing a method for manufacturing a daylighting sheet 10A.

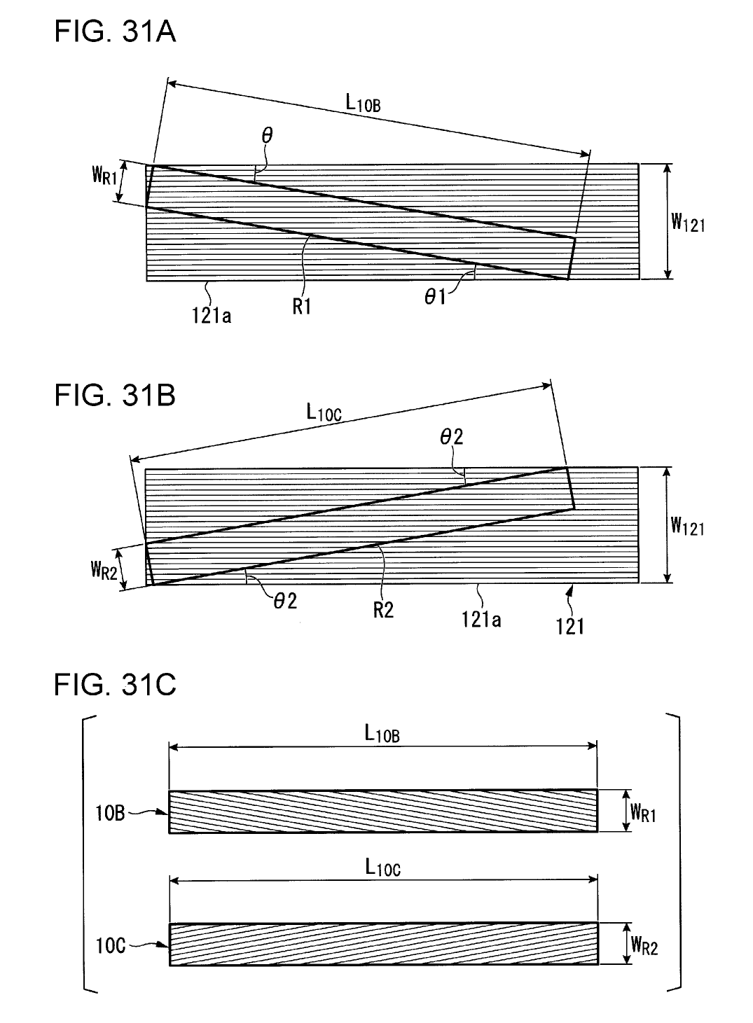

FIG. 31A, FIG. 31B, and FIG. 31C are illustrations for describing a method for manufacturing daylighting sheets 10B and 10C.

As illustrated in FIG. 30A, the daylighting sheet 10A according to the present embodiment is obtained by taking out a whole cloth roll 121 manufactured with the use of a roll-to-roll technique from a take-up roller 122 and by cutting out the whole cloth roll 121 at each daylighting sheet forming region R. Thus, as illustrated in FIG. 30B, the daylighting sheet forming region R taken out from the take-up roller 122 corresponds to a dimension L_{10A} of the daylighting sheet 10A in the lengthwise direction. Depending on the size of the daylighting sheet forming region R, a plurality of daylighting sheet forming regions R are set in the direction of a roll width W₁₂₁ of the whole cloth roll 121, and a plurality of daylighting sheets 10A can be cut out at once.

In addition, as illustrated in FIG. 30C, daylighting portions 42 are formed along the lengthwise direction of the whole cloth roll 121, and thus the daylighting portions 42 extend in the lengthwise direction of the cutout daylighting sheet 10A.

The daylighting sheets 10B and 10C can be manufactured by changing the direction in which the whole cloth roll 121 is cut out from the direction held at the time of cutting out the daylighting sheet 10A. Specifically, the daylighting sheets 10B and 10C can be obtained by taking out the whole cloth roll 121 from the take-up roller 122 and by cutting out the whole cloth roll 121 at each daylighting sheet forming region R1 or each daylighting sheet forming region R2 that extends in a direction (θ1, θ2) inclined relative to the direction in which the whole cloth roll 121 is taken out.

As the daylighting portions 42 are formed along the lengthwise direction of the whole cloth roll 121, as illustrated in FIG. 31A, when the daylighting sheet 10B is manufactured, the daylighting sheet forming region R1 is set at a first angle θ1 relative to an edge side 121a of the whole cloth roll 121. The dimension of the daylighting sheet forming region R1 in the lengthwise direction, namely, the dimension L_{10B} of the daylighting sheet 10B in the lengthwise direction is obtained through the following expression (1).

As illustrated in FIG. 31B, when the daylighting sheet 10C is manufactured, the daylighting sheet forming region R2 is set at a second angle θ2 relative to the edge side 121a of the whole cloth roll 121. The dimension of the daylighting sheet forming region R2 in the lengthwise direction, namely, the dimension L_{10C} of the daylighting sheet 10C in the lengthwise direction is obtained through the following expression (2).

L=(R−B cos θ)/Sin θ (1)

L=(R−B cos(−θ))/Sin(−∂) (2)

In this manner, as illustrated in FIG. 31C, the daylighting sheets 10B and 10C provided with the daylighting portions 42 of which the directions of inclination differ from each other can be manufactured.

According to the manufacturing method described above, the size of the daylighting sheet 10, or specifically the transverse dimension along the right-left direction of a window can be adjusted freely. Therefore, when the size of the daylighting apparatus in the right-left direction of a window is to be increased, by changing the cutout size of the whole cloth roll 121, the daylighting sheet 10 of a variety of sizes can be fabricated.

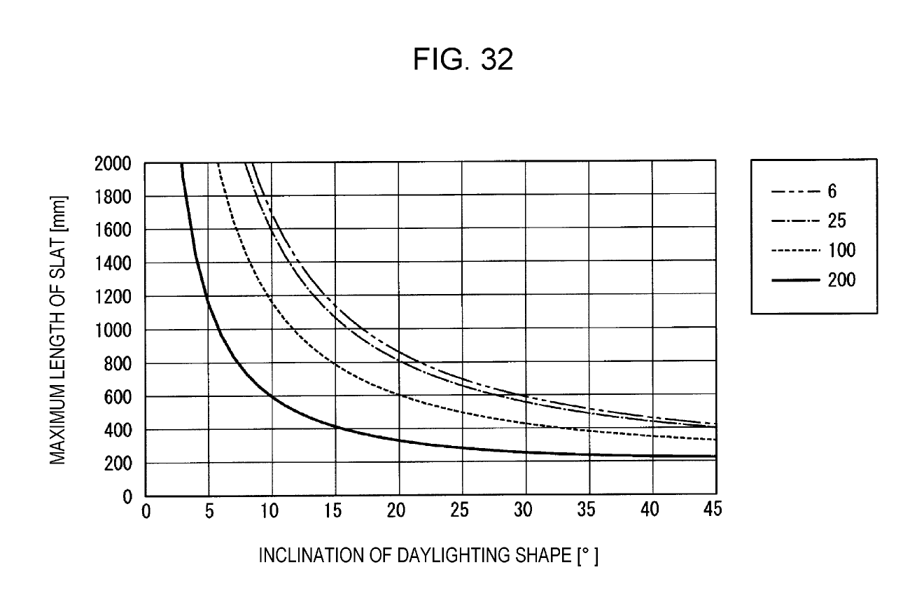

FIG. 32 is a graph illustrating a relationship between an inclination (°) of a daylighting shape in the daylighting sheet 10B and a length (mm) in the lengthwise direction.

Here, a relationship between the size of the daylighting sheet 10B that can be cut out obliquely from a whole cloth roll 141 having a roll width W of 300 mm and the angle of inclination of the daylighting portions 42 will be described.

As illustrated in FIG. 32, when the width (the dimension in the widthwise direction) W of the daylighting sheet 10B increases from 6 mm, 25 mm, 100 mm, to 200 mm, the dimension L of the daylighting sheets 10B and 10C in the lengthwise direction decreases.

It is preferable that the dimension of the daylighting sheet 10B in the lengthwise direction be changed in accordance with the angle of inclination of the daylighting shape. When the angle of the daylighting portions is large, the dimension L of the daylighting sheet 10B in the lengthwise direction is reduced; whereas, when the angle of the daylighting portions is small, the dimension L of the daylighting sheet 10B in the lengthwise direction is increased.

A plurality of types of daylighting sheets in which the angles of inclination of the daylighting portions differ from one another may be prepared, and these may be affixed together. Then, the seams between the daylighting sheets become ragged, and the boundary portions become less noticeable.

Thus far, preferred embodiments according to the present invention have been described with reference to the appended drawings, and it is needless to say that the present invention is not limited to the above examples. It is apparent that a person skilled in the art can conceive of various modified examples and revised examples within the technical spirit set forth in the appended claims, and it should be appreciated that these modified examples and revised examples are encompassed by the technical scope of the present invention.

For example, by adjacently arraying daylighting slats or daylighting sheets having different types of microstructure shapes in the up-down direction, glare light stretched in the up-down direction can be made smaller.

In addition, the configuration may be such that a substrate 41A having daylighting portion 42a that are parallel to an edge side 41d and a plurality of substrates provided with daylighting portions that are inclined at mutually different predetermined angles relative to the edge side 41d are provided.

In other words, in the foregoing embodiments, the configuration is such that one type each of the substrate 41B having the daylighting portion 42b inclined at a first angle θ1 (+10°) and the substrate 41C having the daylighting portions 42c inclined at a second angle θ2 (−10°) is provided. Alternatively, for example, the configuration may be such that a plurality of types of substrates having daylighting portions that are each inclined at θ1 of +5°, +10°, +15°, or +20° are provided. Alternatively, the configuration may be such that a plurality of types of substrates having the daylighting portions that are each inclined at an angle θ1 of +20° or +10° or an angle θ2 of −10° or −20° are provided. Furthermore, in any one of the configurations, the substrate 41A having the daylighting portions 42a that are parallel to the edge side 41d may be included.

In addition, the order in which the plurality of types of substrates are arrayed is not particularly limited, and the substrates may be arrayed in the order of the angles of the daylighting portions or in a random order irrespective of the angles.

### Daylighting System

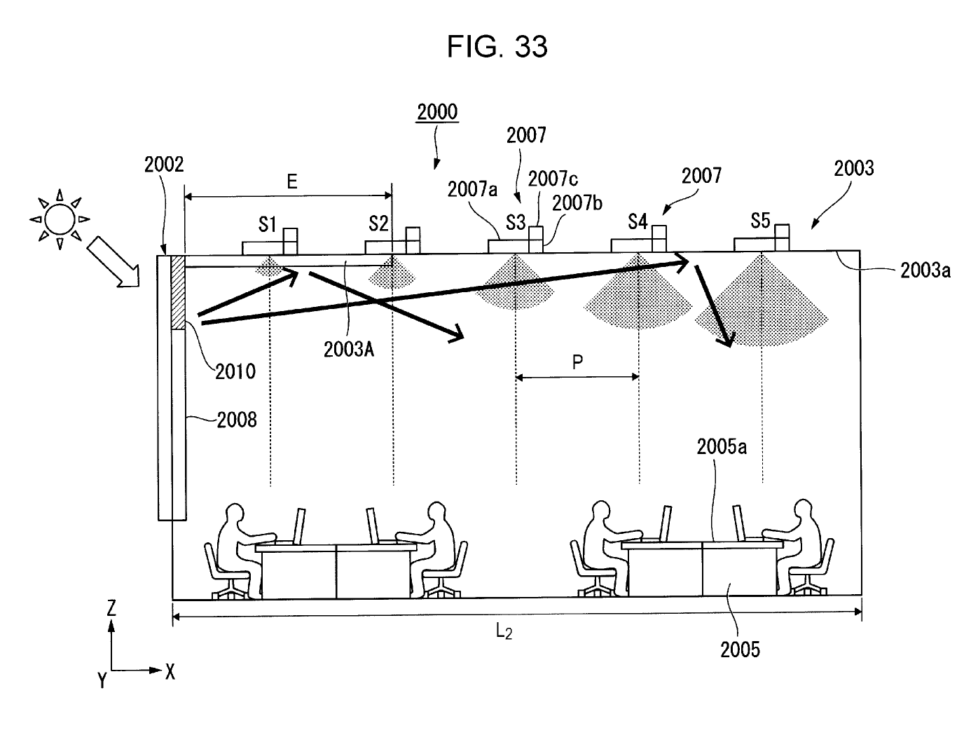

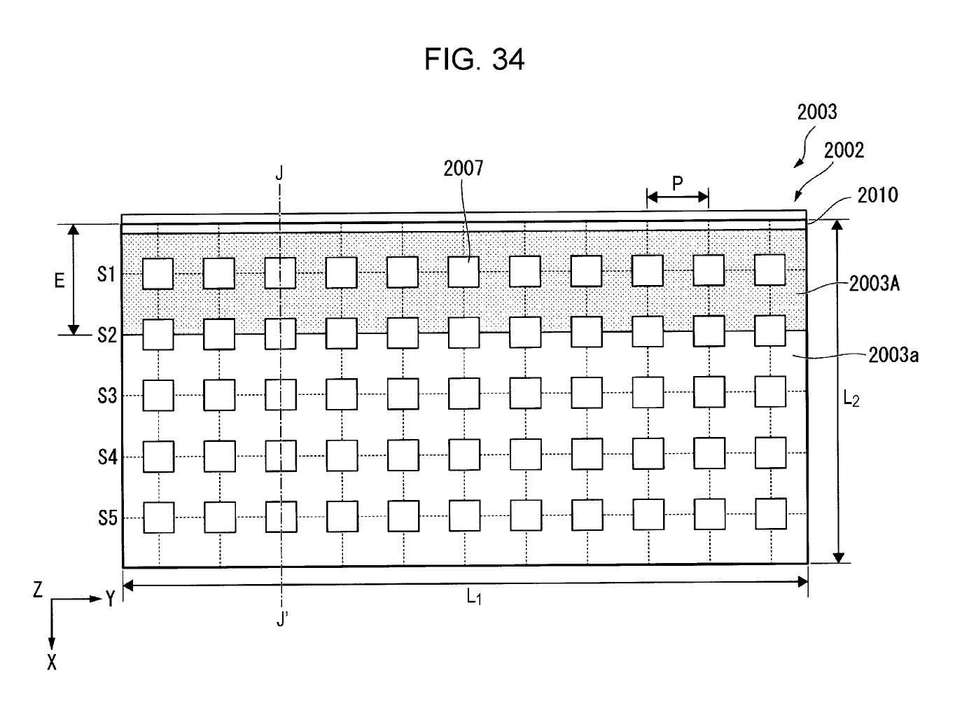

FIG. 33 illustrates a room model 2000 provided with a daylighting apparatus and an illumination control system and is a sectional view taken along the J-J′ line indicated in FIG. 34. FIG. 34 is a plan view illustrating a ceiling of the room model 2000.

In the room model 2000, a ceiling material forming a ceiling 2003a of a room 2003 into which outside light is introduced may have a high light reflecting property. As illustrated in FIG. 33 and FIG. 34, a light reflective ceiling material 2003A serving as a ceiling material having a light reflecting property is installed on the ceiling 2003a of the room 2003. The light reflective ceiling material 2003A is intended to facilitate the introduction of the outside light from a daylighting apparatus 2010 installed at a window 2002 into the back of the room interior and is installed on the ceiling 2003a at the vicinity of the window. Specifically, the light reflective ceiling material 2003A is installed in a predetermined region E (a region within approximately 3 m from the window 2002) of the ceiling 2003a.

As described above, the light reflective ceiling material 2003A works to efficiently guide the outside light introduced into the room interior via the window 2002 at which the daylighting apparatus 2010 (the daylighting apparatus according to any one of the embodiments described above) is installed into the back of the room interior. The outside light introduced toward the ceiling 2003a of the room interior from the daylighting apparatus 2010 is reflected and redirected by the light reflective ceiling material 2003A and illuminates a desk top surface 2005a of a desk 2005 disposed in the back of the room interior, thereby exhibiting an effect of lighting the desk top surface 2005a.

The light reflective ceiling material 2003A may have a diffusively reflective property or a specularly reflective property. In order to achieve both an effect of lighting the desk top surface 2005a of the desk 2005 disposed in the back of the room interior and an effect of suppressing glare light that is unpleasant to a person in the room interior, it is preferable that the two characteristics be mixed appropriately.

A large portion of the light introduced into the room interior by the daylighting apparatus 2010 travels toward the ceiling in the vicinity of the window 2002, but it is often the case that the quantity of light is sufficient in the vicinity of the window 2002. Therefore, by using the light reflective ceiling material 2003A as described above alongside, light incident on the ceiling (region E) in the vicinity of the window can be distributed into the back of the room interior where the quantity of light is smaller than that in the vicinity of the window.

The light reflective ceiling material 2003A can be fabricated, for example, by subjecting a metal plate of aluminum or the like to an emboss process with concavities and convexities of approximately several tens of micrometers or by depositing a metal thin film of aluminum or the like on a surface of a resin substrate in which similar concavities and convexities are formed. Alternatively, the concavities and convexities formed through an emboss process may be formed with curved surfaces of a much larger cycle.

Furthermore, by changing the emboss shape formed in the light reflective ceiling material 2003A as appropriate, the light distribution characteristics or the distribution of the light in the room interior can be controlled. For example, when an emboss process is performed such that a stripe pattern extends toward the back of the room interior, light reflected by the light reflective ceiling material 2003A spreads in the right-left direction of the window 2002 (the direction intersecting the lengthwise direction of the concavities and convexities). When the size or the orientation of the window 2002 in the room 2003 is limited, with the use of the aforementioned property, the light can be diffused in the horizontal direction with the light reflective ceiling material 2003A and can be reflected toward the back of the room interior.

The daylighting apparatus 2010 is used as a part of an illumination control system in the room 2003. The illumination control system is constituted, for example, by constituting members of the entire room including the daylighting apparatus 2010, a plurality of interior illumination apparatuses 2007, an insolation adjustment apparatus 2008 installed at the window, a control system for the above, and the light reflective ceiling material 2003A installed on the ceiling 2003a.

The daylighting apparatus 2010 is installed at the upper side of the window 2002 in the room 2003, and the insolation adjustment apparatus 2008 is installed at the lower side. Here, a blind is installed as the insolation adjustment apparatus 2008, but this is not a limiting example.

In the room 2003, the plurality of interior illumination apparatuses 2007 are disposed in a lattice pattern in the right-left direction (the Y-direction) of the window 2002 and in the depthwise direction (the X-direction) of the room interior. The plurality of interior illumination apparatuses 2007, along with the daylighting apparatus 2010, constitute the illumination system for the entirety of the room 2003.

As illustrated in FIG. 33 and FIG. 34, for example, the ceiling 2003a of an office having a dimension L₁ in the right-left direction (the Y-direction) of the window 2002 of 18 m and a dimension L₂ in the depthwise direction (the X-direction) of the room 2003 of 9 m is illustrated. Here, the interior illumination apparatuses 2007 are disposed in a lattice pattern at an interval P of 1.8 m in each of the transverse direction (the Y-direction) and the depthwise direction (the X-direction) of the ceiling 2003a.

To be more specific, fifty interior illumination apparatuses 2007 are disposed in a matrix of ten rows (the Y-direction) by five columns (the X-direction).

The interior illumination apparatuses 2007 each include an interior illumination device (interior illumination equipment) 2007a, a brightness detecting unit 2007b, and a control unit 2007c and is configured with the brightness detecting unit 2007b and the control unit 2007c being integrated into the interior illumination device 2007a.

The interior illumination apparatuses 2007 may each include a plurality of interior illumination devices 2007a and a plurality of brightness detecting units 2007b. However, only a single brightness detecting unit 2007b is provided for each interior illumination device 2007a. The brightness detecting unit 2007b receives reflection light from an irradiated surface illuminated by the interior illumination device 2007a and detects the illuminance of the irradiated surface. Here, the illuminance on the desk top surface 2005a of the desk 2005 disposed in the room interior is detected by the brightness detecting unit 2007b.

The control units 2007c provided for the respective interior illumination apparatuses 2007 are connected to one another. The control units 2007c, in the interior illumination apparatuses 2007, connected to one another carry out feedback control of adjusting the optical output of an LED lamp in each of the interior illumination devices 2007a so that the illuminance on the desk top surface 2005a detected by each brightness detecting unit 2007b becomes a constant target illuminance L0 (e.g., mean illuminance: 750 1×).

### INDUSTRIAL APPLICABILITY

Some of the aspects of the present invention can be applied to a daylighting member, a method for manufacturing a daylighting member, a daylighting apparatus, and so on that need to suppress intense glare light emerging in a specific direction.

### Reference Signs List

1 BLIND (DAYLIGHTING APPARATUS)
2 SLAT
3 SUPPORT MECHANISM
4, 24, 25 DAYLIGHTING SLAT (DAYLIGHTING MEMBER)
8a ONE SURFACE
10 DAYLIGHTING SHEET (DAYLIGHTING MEMBER)
R_{10A} FIRST REGION
R_{10B} SECOND REGION
R_{10C} THIRD REGION
30, 50 ROLL SCREEN (DAYLIGHTING APPARATUS)
32, 52 DAYLIGHTING SCREEN
33 TAKE-UP MECHANISM
41, 41A, 46, 47, 49 SUBSTRATE
41A SUBSTRATE (FIRST SUBSTRATE)
41B SUBSTRATE (FIRST SUBSTRATE)
41C SUBSTRATE (SECOND SUBSTRATE)
41a, 41b SURFACE
41d, 121a EDGE SIDE
42, 42a, 42b, 42c, 104 DAYLIGHTING PORTION
42a DAYLIGHTING PORTION (THIRD DAYLIGHTING PORTION)
42b DAYLIGHTING PORTION (FIRST DAYLIGHTING PORTION)
42c DAYLIGHTING PORTION (SECOND DAYLIGHTING PORTION)
43 GAP PORTION
60 DAYLIGHTING PANEL (DAYLIGHTING APPARATUS)
62 FRAME
70 DAYLIGHTING FILM (DAYLIGHTING APPARATUS)
θ1 FIRST ANGLE
θ2 SECOND ANGLE
LB, LB1, LB2, LB3 LIGHT
121, 141 WHOLE CLOTH ROLL
2010 DAYLIGHTING APPARATUS

1. A daylighting member, comprising:
a plurality of substrates having a light transmitting property;
a plurality of daylighting portions having a light transmitting property, the plurality of daylighting portions extending linearly on a first surface of each of the substrates and extending in different directions on different substrates; and
a gap portion provided between the plurality of daylighting portions,
wherein the plurality of substrates include
at least a first substrate or a second substrate, the first substrate having a first daylighting portion inclined at a first angle θ1 relative to an edge side of the substrate, the second substrate having a second daylighting portion inclined at a second angle θ2 relative to the edge side.

2. The daylighting member according to claim 1,
wherein the first substrate is provided in a plurality, and
wherein the respective first daylighting portions of the plurality of first substrates are inclined at mutually different first angles θ1.

3. The daylighting member according to claim 1,
wherein the second substrate is provided in a plurality, and
wherein the respective second daylighting portions of the plurality of second substrates are inclined at mutually different second angles θ2.

4. The daylighting member according to claim 1, wherein the first substrate, and the second substrate are arrayed in a direction intersecting the edge side.

5. The daylighting member according to claim 1, wherein the first substrate, and the second substrate are arrayed in a direction parallel to the edge side.

6. The daylighting member according to claim 1, further comprising:
a first substrate having a third daylighting portion that is parallel to an edge side of the substrate.

7. A daylighting member, comprising:
a substrate having a light transmitting property;
a plurality of daylighting portions having a light transmitting property, the plurality of daylighting portions extending linearly on a first surface of the substrate; and
a gap portion provided between the plurality of daylighting portions,
wherein the first surface includes
at least a first region or a second region, the first region having a first daylighting portion inclined at a first angle θ1 relative to an edge side of the substrate, the second region having a second daylighting portion inclined at a second angle θ2 relative to the edge side.

8. The daylighting member according to claim 7,
wherein the first region is provided in a plurality, and
wherein the respective first daylighting portions of the plurality of first regions are inclined at mutually different first angles θ1.

9. The daylighting member according to claim 7,
wherein the second region is provided in a plurality, and
Wherein the respective second daylighting portions of the plurality of second regions are inclined at mutually different second angles θ2.

10. The daylighting member according claim 7, wherein the first region and the second region are arrayed in a direction intersecting the edge side.

11. The daylighting member according to claim 7, wherein the first region and the second region are arrayed in a direction parallel to the edge side.

12. A daylighting member, comprising:
a substrate having a light transmitting property;
a plurality of daylighting portions having a light transmitting property, the plurality of daylighting portions extending linearly on a first surface of the substrate; and
a gap portion provided between the plurality of daylighting portions,
wherein the first surface includes
a plurality of first regions or a plurality of second regions, the plurality of first regions having a first daylighting portion inclined at a first angle θ1 relative to an edge side of the substrate, the plurality of second regions having a second daylighting portion inclined at a second angle θ2 relative to the edge side, the first regions or the second regions being present in a plurality in one direction.

13. The daylighting member according to claim 12, Wherein the first regions and the second regions are present alternatingly in a repeated manner in one direction.

14. The daylighting member according to claim 12, further comprising:
a plurality of third regions having a first daylighting portion that is parallel to an edge side of the substrate.

15. The daylighting member according to claim 1,
wherein the first angle θ1 is within a range of 0°≤θ1≤30°, and
wherein the second angle θ2 is within a range of −30°≤θ2<0°.

16. The daylighting member according to claim 1, wherein the first daylighting portion and the second daylighting portion are inclined symmetrically with respect to a direction intersecting a direction in which the first daylighting portion and the second daylighting portion are arranged.

17. The daylighting member according to claim 1, wherein the edge side is a side extending along a lengthwise direction of the substrate.

18. A method for manufacturing the daylighting member according to claim 1, the method comprising:
cutting out, from a whole cloth roll manufactured with the use of a roll-to-roll technique, a plurality of the third daylighting portions, a plurality of the first daylighting portions, and a plurality of the second daylighting portions.

19. A method for manufacturing the daylighting member according to claim 7, the method comprising:
cutting out, from a whole cloth roll manufactured with the use of a roll-to-roll technique, a plurality of the first daylighting portions and a plurality of the second daylighting portions, thereby obtaining the first substrate and the second substrate.

20. A daylighting apparatus, comprising:
a plurality of slats; and
a support mechanism that couples the plurality of slats with a lengthwise direction of the slats extending in a horizontal direction and supports the plurality of slats in a state of being suspended in a vertical direction,
wherein the plurality of slats include the daylighting member according to claim 1.

21. A daylighting apparatus, comprising:
a day lighting screen; and
a take-up mechanism that allows the daylighting screen to be taken up freely,
wherein the daylighting screen includes the daylighting member according to claim 1.

22. A daylighting apparatus, comprising:
a substrate; and
a frame that supports the substrate at a periphery,
wherein the daylighting member according to claim 1 is provided on one surface of the substrate.
